(19) United States
(12) Patent Application Publication
(10) Pub. No.: US 2003/0041092 A1
(43) Pub. Date: Feb. 27, 2003

(54) System amd method for providing chatting service as well as contents by using network

(76) Inventor: Jong-Hyun Woo, Seoul (KR)

Correspondence Address: Finnegan Henderson Farabow, Garrett & Dunner, 1300 I Street NW, Washington, DC, 20005, US

(21) Appl. No.: 10/182,829

(22) PCT Filed: Feb. 2, 2001
(86) PCT No.: PCT/KR01/00147

(30) Foreign Application Priority Data
Feb. 2, 2000 (KR) 2000/05227
Jun. 15, 2000 (KR) 2000/32940
Nov. 20, 2000 (KR) 2000/69092

(51) Int. Cl. G06F 15/16

(52) U.S. Cl. 709/200

(57) ABSTRACT

The present invention relates to a method and system for providing chatting service and contents on communications network comprising the steps of receiving chatting message from user terminal-the chatting message includes at least one selected from the group consiting of CHATTING CONTROL COMMAND and CONTENTS CONTROL COMMAND, abstracting CONTENTS CONTROL COMMAND from the chatting message, and controlling the contents displayed on the display unit of the user terminal corresponding with the CONTENTS CONTROL COMMAND.

### TECHNICAL FIELD

The present invention relates to a system and method for providing chatting service and contents on communications network. More specially, it relates to the system and method for providing chatting service and contents on communications network to be able to be provided real-time information selectively while a user is engaged in chatting.

### BACKGROUND ART

The means of transmitting information among members of enterprises or social groups have changed in many ways with the development of information technology.

There are generally four types of information transmission. Information can be transmitted: (1) between people communicating at one time and in one place; (2) between people communicating at the same time but in different places; (3) between people sending and receiving information at different times but in the same place; and (4) between people exchanging information both at different times and in different places.

Some means of information transmission that were not possible in the past have now become common because of the development of information technology and they are replacing the existing means of communication. Electronic mail (E-mail) used universally by members of the present society and the systematic society is divided into the means for information transmission at the different time and in the same space or at the different time and in the different space.

However, since it takes some time to send and receive E-mail, which is not the suitable means of communication for people who want to exchange information in real time.

The new means of exchanging information replacing the defect is the chatting system on the communications network.

The following, Let's explain briefly about the method for using the chatting system.

After the member is connected to the web server providing chatting-service based on the communications network for performing communication by means of letters among the members, and then the chatting system create ‘chat room’ where they can communicate with others about special subjects.

When chat room is created, chatting is carried out in writing among the users connected to the site who access that room.

And such a chatting system can identify the user ID of members connected to the same ‘chat rooms’or the user ID of standing members disconnected to the special ‘chat room’and peruse basic information.

After the member has finished using a chat room, he/she disconnects from it by either logging off the chat site or moving to a different Internet site

However, until now chatting systems have been designed only to provide real-time communication in writing among members who want to participate in chatting. Consequently, one drawback of chatting systems is that members who participate in chatting are isolated from other information that is being rapidly exchanged in real time.

Another problem with current chatting systems is that it is hard to develop them for future communications purposes because information is shared only on limited subjects and among a small group of users, and such systems lack access to other real-time information.

Still another problem with current chatting systems is that users cannot be certain about the accuracy of information they acquire because participants in chatting cannot be restricted to people who are knowledgeable about particular subjects.

Also, still another problem with current chatting systems is that communication can be brief and irregular.

Also, still another problem with current chatting systems is that information transmitted in writing is not up-to-date, because current chatting systems are unable to provide accurate information on rapidly changing conditions or make use of graphics to supplement such information.

Also, still another problem with current chatting systems is that they do not allow the users to exchange information simultaneously, but only in one-sided exchanges; this is because chatting systems cannot be altered to meet the needs of the users, even though they can provide real-time information via a chat window.

Also, still another problem with current chatting systems is that members using the chatting system for study purposes or just out of interest cannot take part in dialogues or information sharing for a long period because chatting systems require all members to have common interests in order to continue participating in chat rooms.

### DISCLOSURE OF THE INVENTION

The present invention is devised to solve the above-mentioned problems.

An object of the present invention is to provide the system and method for providing chatting service and contents on communications network to be able to provide, hold in common and use the information by outputting only special user appointed by the user a real-time information corresponding to a chatting message input by the user.

Another object of the present invention is to provide the system and method for providing chatting service and contents on communications network to be able to remove complication and limitations upon providing the latest information through the participation of members who chat about information that changes rapidly in real-time.

Still another object of the present invention is to provide the system and method for providing chatting service and contents on the communications network to be able to process chatting efficiently because members are provided with brief and accurate information about rapidly changing conditions through the use of schematics.

Still another object of the present invention is to provide the system and method for providing chatting service and contents on the communications network to be able to transmit information of spontaneous type among the users because real-time information can be convertible automatically according to the request of the user

Still another object of the present invention is to provide the system and method for providing chatting service and contents on the communications network to be able to communicate future-directional and developmental by means of using the information.

Still another object of the present invention is to provide the system and method for providing chatting service and contents on the communications network that chatting-participant are can process chatting developmental based on correct reality by means of real time information provided in real-time

Still another object of the present invention is to provide the system and method for providing chatting service and contents on the communications network to be able to form space to enable communication protractedly and periodical.

Still another object of the present invention is to provide the system and method for providing chatting service and contents on the communications network to be able to enhance the whole development of members because the members participating in chatting can discuss, study and predict through the information.

To achieve the object, in accordance with one preferred embodiment of the present invention, there is provided with the method and the system for providing chatting service and contents on communications network, comprising the steps of receiving chatting message from a user terminal-the chatting message includes at least one selected from the group consisting of CHATTING CONTROL COMMAND and CONTENTS CONTROL COMMAND; abstracting CONTENTS CONTROL COMMAND from the chatting message; and controlling the contents displayed on the display unit of the user terminal corresponding with the CONTENTS CONTROL COMMAND.

Also the CONTENTS CONTROL COMMAND includes at least one selected from the group consisting of USER TYPE APPOINTMENT COMMAND and CONTENTS TYPE APPOINTMENT COMMAND. And the USER TYPE APPOINTMENT COMMAND includes identification symbol to be determined beforehand. Moreover the CONTENTS TYPE APPOINTMENT COMMAND includes at least one selected from the group consisting of identification code, item name and item code to be determined beforehand. Here, the identification symbol to be determined beforehand includes at least one selected from the group consisting of /, =, \, !, @, #, $, %, ˆ , &, *, ?.

Also, the different identification symbol is assigned to the USER TYPE APPOINTMENT COMMAND according to the contents control range among the users who are participating in chatting. And the contents are displayed in a chat window providing the chatting service. Moreover the contents displayed in the chat window can display in separate window independently when the user requests. Also the contents are displayed in separate frame from the chatting service.

In accordance with another preferred embodiment of present invention, there is provided with the method and system for providing chatting service and contents on a communications network, comprising the steps of receiving connection request information from a plurality of user terminals; searching chatting program from a storage device; transmitting the searched chatting program to the user terminal; receiving connection request information from the chatting program stored in the user terminal; transmitting initialization information of ‘chat room’ to the user terminal; receiving chatting message from the user terminal, wherein the chatting message includes at least one selected from the group consisting of the CHATTING CONTROL COMMAND and the CONTENTS CONTROL COMMAND; judging that the chatting message includes either CHATTING CONTROL COMMAND or CONTENTS CONTROL COMMAND; and controlling corresponding service according to the judgment result,

Also the step of controlling corresponding service according to the judgment result is the step of controlling the chatting service when the chatting message includes the CHATTING CONTROL COMMAND and controlling contents when the chatting message includes the CONTENTS CONTROL COMMAND. And the CHATTING CONTROL COMMAND includes at least one selected from the group consisting of conversation information, whisper information, synchronization share information and synchronization rejection information.

In accordance with another preferred embodiment of present invention, there is provided with the method and system for providing chatting service and contents on a communications network, comprising the step of receiving connection request information from a user; receiving environment setting information of a real-time information list desired by the user; searching for the real-time information corresponding to the environment setting information of the real-time information list; transmitting initialization information of the ‘chat room’ with the searched information to the user terminal simultaneously; receiving chatting message from the user; abstracting CONTENTS CONTROL COMMAND from the chatting message; and controlling the contents displayed on display unit of the user terminal according to the CONTENTS CONTROL COMMAND.

And the method and system further comprises the steps of receiving selection information of a plurality of users for contents share from the user terminal; transmitting renewal request information of share user list to the user terminal, wherein the renewal request information of share user list renews user list for share of search information based on the received selection information.

Also the method and system further comprises the steps of receiving the user selection information for rejection of contents share from the user terminal; and transmitting renewal request information of share rejection user list to the user terminal, wherein the renewal request information of share rejection share user list renews user list for share of search information based on the received selection information.

In accordance with another preferred embodiment of present invention, there is provided with the method and system for using chatting service and contents on a communications network, comprising the step of transmitting chatting service performance request to the central server providing chatting service; receiving chatting applet from the center server; and being performed the received chatting applet automatically, wherein the chatting applet performs the steps of being input chatting message from the user; transmitting the chatting message to the central server; receiving the chatting message from the central server; and displaying the chatting message on display unit of the user terminal when the received chatting message must displayed on the display unit of the user terminal.

Also the method and system further comprises step of receiving at least one selected from the group consisting of contents and CONTENTS CONTROL COMMAND from the central server; and displaying the contents on display unit of the user terminal when the received contents must displayed on the display unit of the user terminal.

And the step of displaying the contents on the display unit of the user terminal, further comprises the step of recognizing URL included in contents; connecting to the recognized the URL; and receiving automatically information corresponding to the connected the URL.

In accordance with another preferred embodiment of present invention, there is provided with the method and system for using chatting service and contents on communications network, comprising the steps of transmitting SCRREN DIVISION/ASSIGNMENT COMMAND dividing screen into a plurality of areas to a user; receiving chatting message from the user; judging that the received chatting message includes either CHATTING CONTROL COMMAND or CONTENTS CONTROL COMMAND; providing service according to the judgment result; and displaying contents relation transaction screen on the monitor of the user terminal when the service is provided.

Also the step of transmitting the SCRREN DIVISION/ASSIGNMENT COMMAND is at least one selected from the group consisting of the first area, the second area, the third area and the forth area—the first area outputs CHATTING CONTROL COMMAND represented by letters, the second area outputs a real-time information about item selected by the user, the third area outputs a real-time information related to CONTENTS CONTROL COMMAND information included in the chatting message and the forth area is area that the user inputs and transmits the transaction information—.

Also the forth area is assigned to command server for performing the contents relation transaction—the command server provides transaction service like stocks, presents or option on online—. And the content relation transaction screen includes link about web site for performing contents relation transaction.

In accordance with another preferred embodiment of present invention, there is provided with the method for generating screen of chatting service and contents on communications network, a plurality of information areas displayed on a singular screen comprising: the first area for outputting CHATTING CONTROL COMMAND represented by letters, wherein the CHATTING CONTROL COMMAND is input and transmitted from a plurality of users; the second area for outputting real-time information about item selected by the user; and the third area for outputting real-time information related to CONTENTS CONTROL COMMAND information included in chatting message of the user.

The method further comprises the forth area, wherein the forth area is the area for inputting and transmitting transaction information based on information provided the schematic a plurality of areas.

Also the third area further comprises the search area for searching special information input by the user. And the third area is displayed on the first area.

### BRIEF DESCRIPTION OF THE DRAWINGS

The above objects and other advantages of the present invention will become more apparent in detailed descriptions of the preferred embodiments thereof with reference to the attached drawings, in which:

FIG. 1a and FIG. 1b are schematic illustrations of system for providing chatting service and contents on communications network in accordance with one preferred embodiment of the present invention;

FIG. 2 is a schematic illustration of system for providing chatting service and contents on the communications network in accordance with another preferred embodiment of the present invention;

FIG. 3 is a flow chart illustrating the synchronization of chatting information and real time information in accordance with still another preferred embodiment of the present invention;

FIG. 4 is a flow chart illustrating the steps of providing chatting message in accordance with still another preferred embodiment of the present invention;

FIG. 5 is a flow chart illustrating the synchronization of chatting information and real time information in accordance with still another preferred embodiment of the present invention;

FIG. 6 is a flow chart illustrating the synchronization of chatting information and real time information in accordance with still another preferred embodiment of the present invention;

FIG. 7 is a flow chart illustrating for providing chatting service and contents on the communications network in accordance with still another preferred embodiment of the present invention;

FIG. 8 is a flow chart illustrating for providing real time information through chatting information in accordance with still another preferred embodiment of the present invention;

FIG. 9a and FIG. 9b are illustrations of synchronization of chatting information and real time information in accordance with still another preferred embodiment of the present invention;

FIGS. 10 through FIG. 12 is illustrations of synchronization of chatting information and real time information in accordance with still another preferred embodiment of the present invention;

FIG. 13 and FIG. 14 are illustrations of synchronization of chatting information and real time information in accordance with still another preferred embodiment of the present invention.

### THE BEST MODES FOR CARRYING OUT THE INVENTION

Hereinafter, preferred embodiments of the present invention will be described in more detail with reference to the accompanying drawings, but it is understood that the present invention should not be limited to the following embodiments.

In explanations of the preferred embodiments of the present invention, terms will be used that are defined as follows.

The chatting message is conversation information that a plurality of the users input for providing the chatting service. The chatting message comprises CHATTING CONTROL COMMAND and CONTENTS CONTROL COMMAND.

The CHATTING CONTROL COMMAND means chatting message presented by the text type of conversation involving a plurality of users. Such CHATTING CONTROL COMMAND includes conversation information of special whisper function in addition to ordinary text.

The CONTENTS CONTROL COMMAND means chatting message that user using chatting-service inputs in order to request contents. The CONTENTS CONTROL COMMAND includes USER TYPE APPOINTMENT COMMAND and CONTENTS TYPE APPOINTMENT COMMAND.

USER TYPE APPOINTMENT COMMAND is to appoint chatting-participant in order to share contents requested by special chatting-participant. For example, the USER TYPE APPOINTMENT COMMAND is can be applied to the type of identification symbol(/, %, =etc).

CONTENTS TYPE APPOINTMENT COMMAND is to appoint a kind or a type of contents requested by special chatting-participant. For example, the CONTENTS TYPE APPOINTMENT COMMAND is can be applied to numerals or letters.

Accordingly, when a special chatting-participant inputs chatting-message in the form of ‘/G Samsung electronic’ or ‘=Samsung electronic, the symbols ‘/’ or ‘=’ to may be recognized as being used in the USER TYPE APPOINTMENT COMMAND.

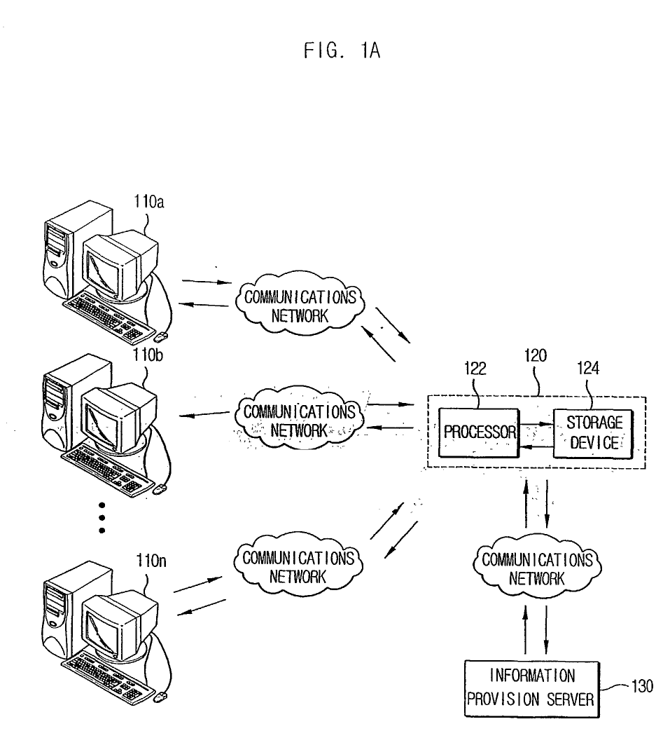

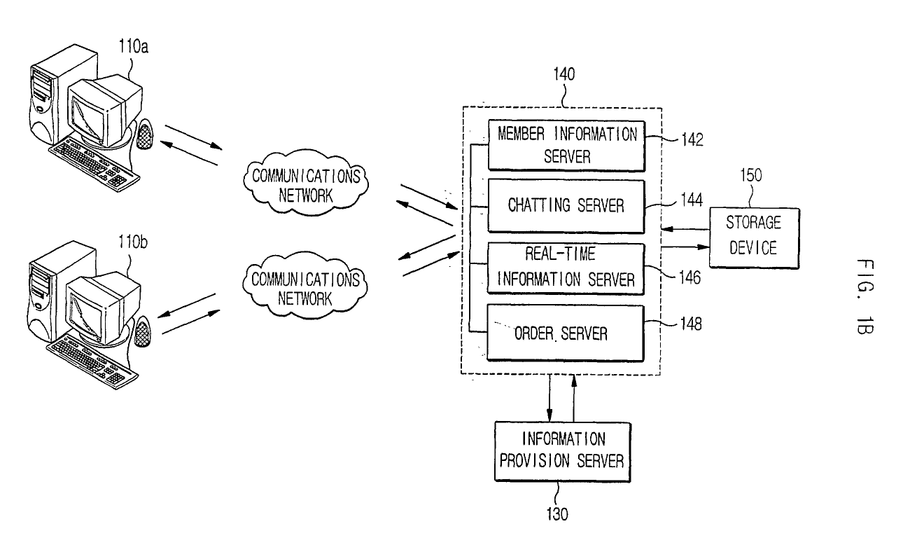

FIG. 1a is a schematic illustration of system for providing chatting service and contents on the communications network in accordance with one preferred embodiment of the present invention.

Referring to FIG. 1a, the system for providing chatting service and contents comprises a plurality of user terminals(110a, 110b, . . . , -below, name 110), a central server(120) and an information-providing server(130).

Each user terminal(110) is able to make use of any other terminal provided that the terminals (110) are equipped with a communication device so as to be able to connect with the central server (120) on the communications network. The user's terminal (110) may be comprised of a computer, a mobile communication terminal, or a PDA.

The central server(120) can include a processor(122) and storage device(124) and provide chatting service to a plurality of users. Also, the central server(120) can provide the real-time information to the user when the user requests the real-time information or the real-time information coincides with a defined condition

The storage device (124) can be used for various purposes: as a member information storage device for storing information about members; as an environment-setting storage device for storing information list that the user wants to be provided with; or as a real-time information storage device for storing data that changes in real time on the web.

Of course, information provided through the present of invention will be general information(for example, non real-time information, historical information.) in addition to the real-time information, but the present special action describes to focus on the real-time information provision aspect of its function.

Moreover, the central server (120) can be organized so that it is divided into a chatting server to provide a chatting-service and a real-time information server to provide real-time information according to its intended purpose.

The following simply explains the present invention by using a schematic illustration of system for providing chatting-service as well as contents by using the communications network illustrated FIG. 1a.

For convenience of explanation, the user terminal (110) referred to will be assumed to be the computer.

The user selects the chatting-service connection to a central server (120), using a computer (110) that is connected to the communications network. At this time, depending upon the user's needs, the user can connect to the previously created chat room or create the new chat room.

The user then inputs the chatting message (for example, “Hello”) in the chatting message input area previously created for processing chatting. The chatting message that the user inputs is displayed on at least one screen of the user computer (110), which is connected to an operating processor (122) in the central server's computer (120).

At this time, when the user wants the real-time information(for example, a current, a volume, an upper limit, a lower limit, a composite stock price index) while chatting and the user can input the request information in the chatting message input area, and then the corresponding real-time information is output automatically in the real-time information providing area.

And the real-time information provided through the communications network according to the request of the user is information that central server(120) collects from a plurality of the connected information provision servers(130) and then stores in the storage device(124). The corresponding real-time information can includes stock information, news, entertainment news, sports news, internet broadcasting and public broadcasting.

The following flow chart illustrates in detail the method for automatically displaying requested real-time information in a predetermined area and while the user is chatting.

FIG. 1b is a schematic illustration of the system for providing chatting service and contents on the communications network in accordance with one preferred embodiment of the present invention.

Referring to FIG. 1b, the system for providing chatting service and contents includes a plurality of user terminals(110) coupled to the communications network, an operator server(140), a storage device(150) and an information-provision server(130).

A schematic illustration in FIG. 1b is similar to that in FIG. 1a, the following is a detailed explanation of the components of the operator server (140), and the method for transmitting data between user terminals (110), and the operator server (140).

Through its connection with the user terminals (110), the operator server (140) performs various roles, constituting a member information server (142), a chatting server (144), a real-time information server (146), and a command server (148).

The member information server(142) is the means of managing the information related to the members including the registration of a membership and member information amendments by the corresponding user.

The chatting server(144) is the means of transmitting the corresponding CHATTING CONTROL COMMAND to a plurality of user terminals(110) or to the special user terminal when the CHANTING CONTROL COMMAND is received from the plurality of user terminal(110)

The real-time information server(146) is the means of processing operations related to the CONTENTS CONTROL COMMAND when the CONTENTS CONTROL COMMAND information including the chatting message is received from the user terminal(110)

The command server(148) is the means of receiving the information related to transaction including buy or sell from the user terminal(110) and transmitting the corresponding information to the information-provision server(130) performing the corresponding transaction.

A plurality of the servers is also able to operate separately and also connect with each other when doing the same work.

The following, referring to FIG. 1b, explains another preferred embodiment of the present invention.

The chatting server(144) receives chatting message(for example, includes the conversation information, the whisper information, the CONTENTS CONTROL COMMAND information) transmitted from the user terminal(110). When the corresponding information is input to update the member information, the corresponding information is transmitted to the member information server(142). Also when the corresponding information is the CHATTING CONTROL COMMAND including the conversation information and the whisper information, the corresponding information is transmitted to the chatting server(144). When the corresponding information is the CONTENTS CONTROL COMMAND information including a quotation inquiry, the corresponding information is transmitted to the real-time information server(146). When the corresponding information is the transaction information such as selling the stock, buying the stock, the corresponding information is transmitted to the command server(148).

Among other possible types of the inputted information, when the corresponding information is the CONTENTS CONTROL COMMAND information such as the quotation inquiry, the real time information server(146) searches the corresponding contents related to the CONTENTS CONTROL COMMAND information in the storage device(150), and transmits the corresponding information to the plurality of user terminals(110). In this case, a plurality of the user terminals(110) receives contents and outputs when necessary, display the corresponding information on the display unit of the user terminal.

Also, when contents searched in the real-time information server(146) is transmitted to the chatting server(144) and it is necessary to transmit the corresponding contents to the user terminal, the chatting server(144) transmits the corresponding contents to the corresponding user terminal

According to another preferred embodiment of the present invention, the present invention can provide the system to provide the chatting service along with the real-time information to be able to being divided and that is transmitted from the user terminal

The information transmitted to the manager server(140) from the user terminal(110) can be used to be restricted by a dividing method.

That is to say, the information can be organized into types, such as the member information for input or updating of the information of the user, the conversation information for output to an unlimited number of users, the whisper information for output to the special user, the real-time request information for request perusing the current quotation of the item that the user wants, or the transaction request information, such as buying or selling stock.

So, when an individual code is assigned to each kind of information item and that code is transmitted with the corresponding information, the information won't be concentrated on a special server and tasks can be performed by connecting with the corresponding servers independently.

For example, the member information server(142) manages the information with a “01” code, the chatting server (144) manages the information with a “02” code, the real-time the information server (146) manages the information with a “03” code, and the command server (148) manages the information with a “04” code.

When the user terminal (110) transmits the inputted information to the operator server (140), the information related to the member information is transmitted with the “01” code, the information related to the CHATTING CONTROL COMMAND including the conversation information and the “whisper” information is transmitted with the “02” code, the real-time information is transmitted with the “03” code, and the information related to the transaction request is transmitted with the “04” code. Those codes are transmitted to the related server, which divides information according to its codes.

large amounts of information are not concentrated at one server but can be divided among numerous servers for management purposes, therefore the system is able to provide a more efficient chatting service.

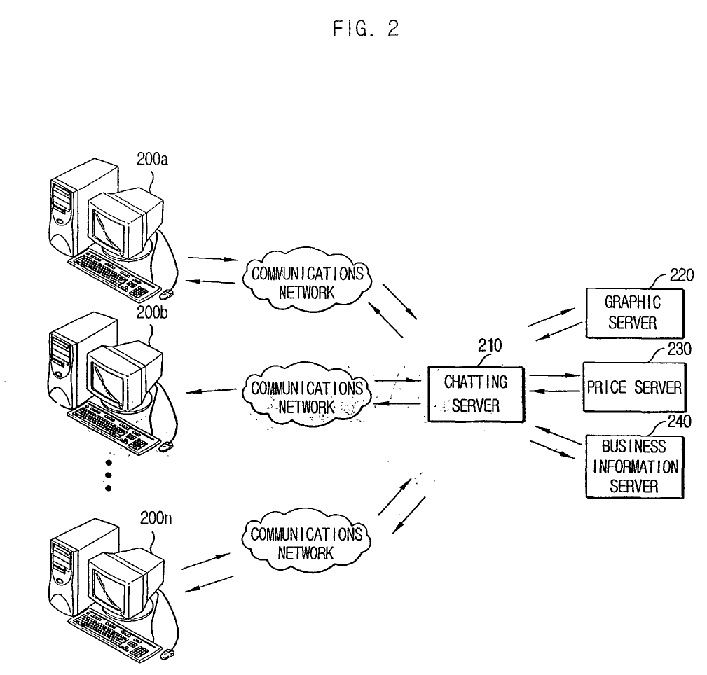

FIG. 2 is a schematic illustration of system for providing chatting service and contents on the communications network in accordance with another preferred embodiment of the present invention.

Referring to FIG. 2, the system for providing chatting service and contents includes a plurality of user terminals(200), a chatting server(210), a graphics server(220), a price server(230) and a business information server(240).

Referring to FIG. 1a and FIG. 1b, an explanation of the same components of the system will be omitted, but the system illustrated in FIG. 2 is very different in the composition of the server.

That is, the composition of the server illustrated in FIG. 1a is explained as the method of providing the chatting service and contents either using one central server (120 in FIG. 1) or a separate chatting server and real-time information server.

However, the system illustrated in FIG. 2 is composed of one chatting server (210) and a plurality of real-time information servers (that is, the graphics server (220), the price server (230), and the business information server (240)).

This information system is able to have separate servers for handling each kind of information independently, such as a transaction server, a stock option server in addition to the graphics server(220), the price server (230), and the business information server (240).

The chatting server (210) first collects real-time information transmitted from the information provision server (130), and then assigns the information to the suitable real-time information servers and transmits the information to the suitable real-time information servers. In; other way, the division function can be processed for the independent server, and then each real-time information server directly collects the suitable information from the information provision server.

In accordance with another preferred embodiment of the present invention, the chatting server (210) can be comprised of two servers. For example, the chatting server (210) can be divided into a server processing only the chatting messages and a web server processing web functions. The web server authenticates the user inputting a user name and a password. When the authenticated user selects the chatting service and contents on the communications network provided by the present invention, the web server performs the function of downloading the program to the user's computer, or else transmits the necessary commands for services whenever services are requested.

Here, the program for downloading software to a client includes the command that divides the screen into at least three areas, assigning the first area to the chatting server and the second area to the real-time information server. The format of the client's monitor screen is determined by the download command. The screen is divided into at least three areas (the first area, the second area, and the third area). The first area is assigned to the chatting server, the second area is assigned to the real-time information server, and the third area is assigned to the transaction server.

Referring to FIG. 2, the following is a concrete description of the system for providing the chatting service on the communications network in accordance with another preferred embodiment of the present invention.

In accordance with another preferred embodiment of the present invention, there is provided with the system for providing the chatting service and contents on the communications network to be able to provide real-time information for the suitable user by making use of the chatting server(210) and each real-time information-provision server.

The user connects to the chatting server(210) in order to use the chatting service with a plurality of other users. And, the special user requests the special real-time information while chatting with a plurality of users by means of the chatting server(210) and then the special real-time information is provided for the corresponding user or the corresponding user with another.

When the corresponding user requests for chart about a special item including a daily chart, a weekly chart, a monthly chart, the chatting server(210) transmit the corresponding CONTENTS CONTROL COMMAND to the graphic server(660) and the chatting server(210) receives the chart from the graphic server(660) and transmits the received chart to the suitable user.

In the same way, when the user requests the contents, the chatting server (210) transmits the corresponding CONTENTS CONTROL COMMAND to the price server (230). And when the user request the information concerning business reports for special businesses, the chatting server (210) transmits the corresponding CONTENTS CONTROL COMMAND to the business information server (240).

Because information-provision functions are divided among various servers, the chatting server (210) only needs to manage the chatting and CHATTING CONTROL COMMAND, and it is therefore able to efficiently manage the chatting service and contents even when a plurality of users are chatting simultaneously.

In accordance with another preferred embodiment of the present invention, there is provided with the system of chatting service and contents on the communications network to be able to provide the real-time information for the suitable user by making use of the chatting server(210) and each real-time information-provision server.

The chatting server(210) receives the information provided by the real-time information-provision server and transmits the information to the user. So the chatting server(210) intervenes in the process of the real-time information provision indirectly.

In accordance with another preferred embodiment of the present invention, the real-time information provision server receiving the special CONTENTS CONTROL COMMAND from the chatting server(210) can provide the corresponding real-time information to the user directly(that is, not via the chatting server(210))

Accordingly, when the user requests the daily chart, the chatting server(210) transmits the corresponding CONTENTS CONTROL COMMAND to the graphic server(220), and the graphic server(220) search for the daily chart stored in the storage device and directly transmits the searched daily chart to the user.

In accordance with another preferred embodiment of the present invention, there are provided with the system for providing the chatting service and contents on the communications network to be able to provide the real time information output only based on users' needs by inspecting the real-time information transmitted from the chatting server (210) to the user terminal.

When user inputs the CONTENTS CONTROL COMMAND while chatting, the chatting server(210) transmits the corresponding CONTENTS CONTROL COMMAND to the real-time information provision server corresponding to the CONTENTS CONTROL COMMAND received from the user and receives corresponding information from the corresponding real-time information provision server.

When the chatting server(210) transmits the real-time information received from the real-time information-provision server to all user connected to the corresponding ‘chat room’, the real-time information, when necessary, can be output on the screen of the user terminal by operating the chatting program established the user terminal.

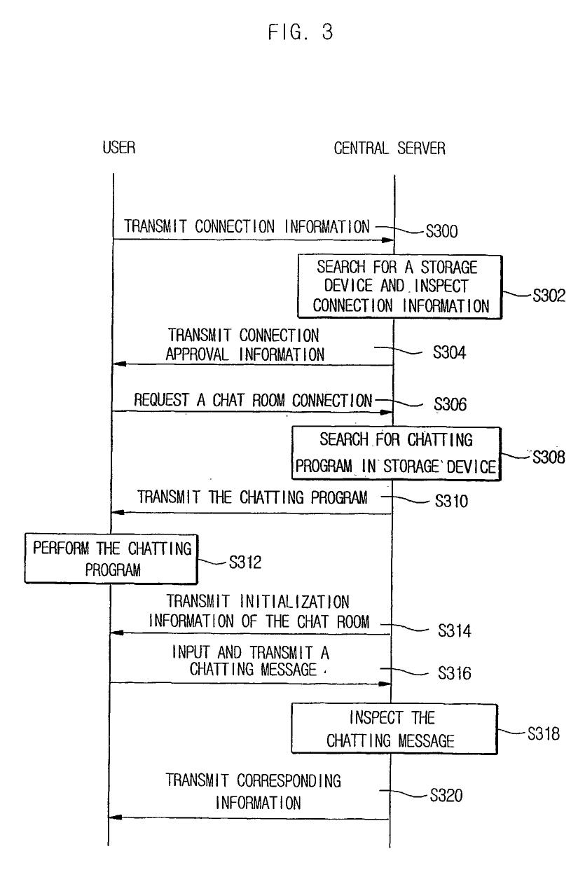

FIG. 3 is a flow chart illustrating the synchronization of chatting information and the real time information in accordance with one preferred embodiment of the present invention.

FIG. 3 shows data flow between user computers and the central server(120) for the synchronization of the chatting information and the real-time information.

Referring to FIG. 3, the user is connected to the central server(120) by means of the user computer connected to the communications network and transmits the connection information including the user identification(ID) and the password through the communications network in step 300.

The central server(120) searches for the storage device and inspects whether or not the connection information received from the user computer through the step 300 is valid in the step 302.

when the connection information is valid, processes to the step 304, the connection approval information is transmitted to the user computer through the communications network.

Of course, when the connection information is not valid, the central server(120) request inputting the correct connection information or request that the user registers for the membership.

The user transmits the connection request information requesting connection to the special ‘chat room’ in order to process chatting with a plurality of users to the central server(120) by means of the user computer in step 306.

Moreover, in this case, the corresponding user is able to create their own new chat room or can connect to a chat room created previously by another user.

The central server(120) searches for the chatting program(for example, chatting applet) in the storage device in step 308. Thereinafter, in step 310, the central server(120) transmits the chatting program searched through the step 308 to the user computer through the communications network (110)

The user computer receives the chatting program transmitted through the step 310 in step 312. The received chatting program is established in the user computer and functions automatically (At this point, the chatting program can be established either permanently or temporarily in the user's computer according to the situation.).

And, the chatting program established in the user computer receives the initialization information for setting up a chat room via the central server (120) in step 314.

The user transmits the chatting message input in the chatting message input area of the ‘chat room’ screen output in the user computer screen to the central server(120) through the communications network in step 316.

The central server(120) inspects whether or not the chatting message received for the step 316 is input and transmitted on a special object.

The chatting message received for step 318 is the CHATTING CONTROL COMMAND to process chatting or the whisper or the CONTENTS CONTROL COMMAND for requesting the real-time information.

Also, when the corresponding chatting message is the CONTENTS CONTROL COMMAND for requesting the real-time information, the user can select one from the group of only corresponding users transmitting corresponding chatting message, all user connected to the same ‘chat room’, only partial user in the same ‘chat room’

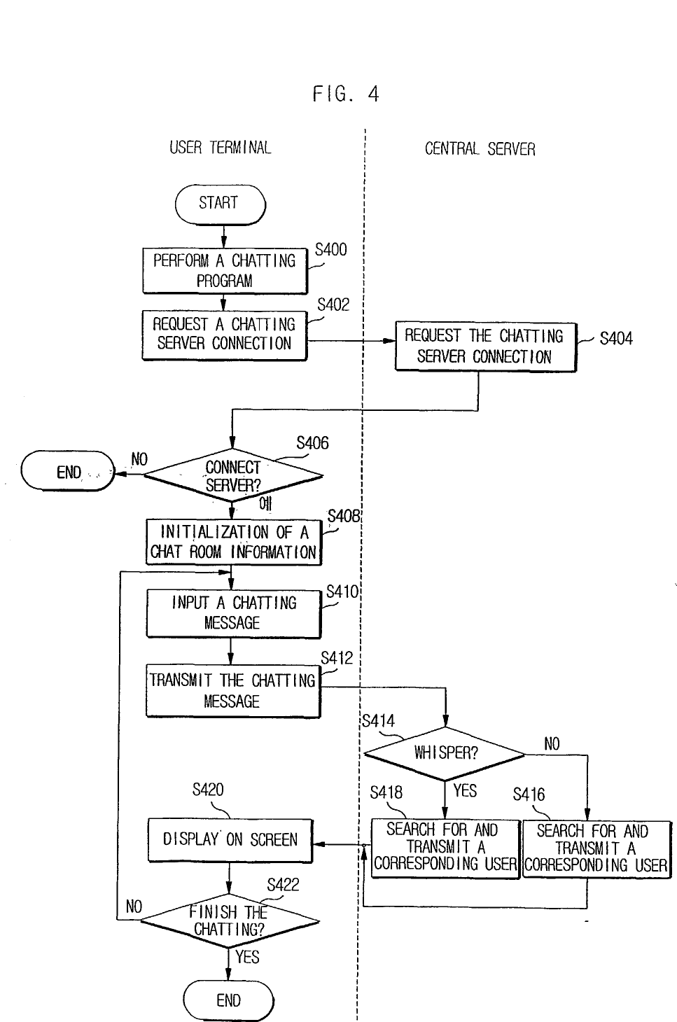

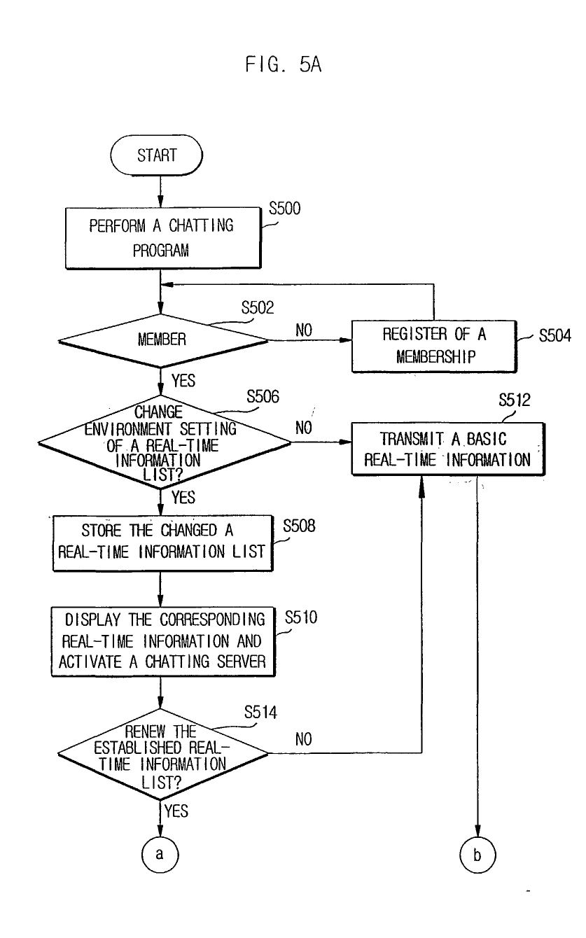

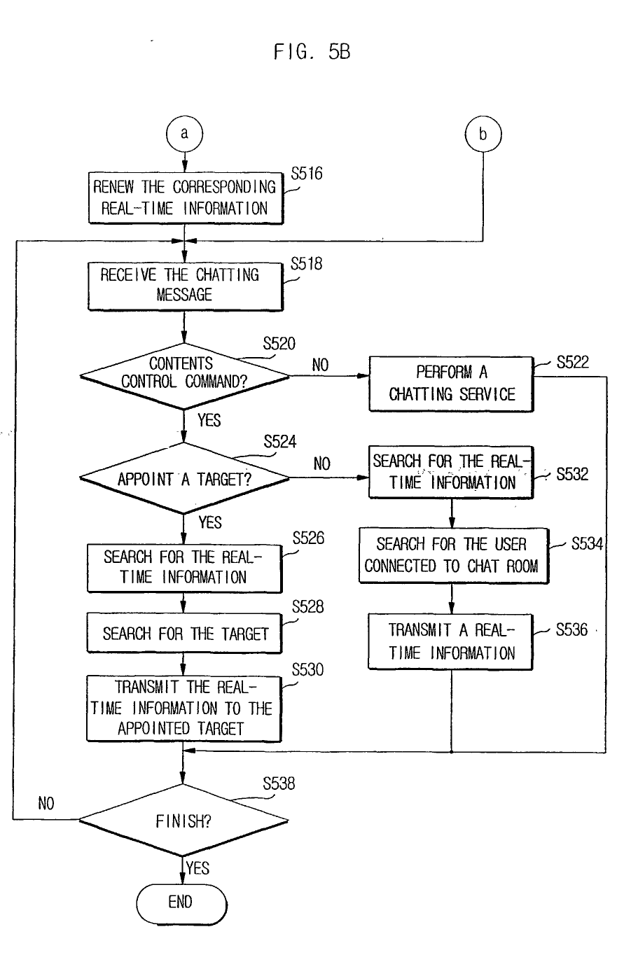

The central server(120) transmits corresponding information(that is, the CHATTING CONTROL COMMAND or the CONTENTS CONTROL COMMAND) to the suitable user according to the results of the inspection in step 318. After this, describe in detail referring to FIG. 4 and FIG. 5 about the step 318 and step 320.

FIG. 4 is a flow chart illustrating the steps of providing chatting message in accordance with still another preferred embodiment of the present invention.

Referring to FIG. 4, the user terminal performs the chatting program received from the central server(120) in step 400.

In running the chat program downloaded in step 400, the user transmits connection request information to the chatting server (either the operator server or a special kind of real-time information server when the operator server is comprised of a group of servers), which operates the chatting program (for example, a chatting applet) in step 402.

The central server transmits the initialization information to set up the corresponding chat room based on the connection request information received by the chatting server in step 402 and step 404. (When there is a plurality of servers, the central server is the special chatting server and other servers are called “chatting servers.”)

The user terminal inspects whether or not the user terminal is connected to the chatting server based on the received initialization information.

When the user terminal is connected to the chatting server, processes to the step 408. When the user terminal is not connected to the chatting server, the step is ended or the central server can perform the chatting server connection request repeatedly processing to the step 402. the user terminal displays a plurality of input areas (for example, a chatting window and a “whisper” message area), an area for inputting the chatting messages, and an area for outputting the conversation information corresponding to the CHATTING CONTROL COMMAND.

Also, the contents corresponding to the real-time information list appointed previously by the user is transmitted on the screen of the user terminal in real time.

Then, the user inputs the chatting message on the chatting message input area in step 410 and the chatting server receives the conversation information input in step 412.

The step transmitting the chatting message input in the step 412 to the chatting server includes the step to insert a message folder expressing character of the chatting message,

Also, the step to insert the message folder to be able to be included in the step 412 can be used to grant the suitable code according to the character of the corresponding chatting message.

The chatting server can differentiate between the conversation information and the “whisper” information (that is, the conversation information provided only to the special user) by means of the code information or determining whether the message folder was inserted in step 412.

We will now describe in more detail the conversation information used to process. For example, When a particular user (for example, a user with the ID “estorm”) inputs the conversation information, “Hi,” using the chat window area, the conversation information is transmitted to the chatting server in the form, “##CHATTING##estorm#$1Hi#$12.”

That is, the conversation information received by form of ‘[##CHATTING##]#$1[contents]#$[letter color]’ is output on all user screen connected to the same ‘chat room’.

Also, let's look into the conversation information for the whisper. For example, when the special user(for example, user to have identification of estorm)inputs the whisper of ‘This is whisper’ using whisper area and transmits the conversation information to the user to have “hee’ID, the form received to the chatting server is ‘##TO##estorm#$1hee#$1 this is whisper#$12’

That is, the conversation information received by form of ‘[##TO##][transmitter]#$1[recipient]#$1[contents]#$[letter color]’ is output on the user screen appointed of recipient.

The use of the corresponding conversation information is classified by including the message folder divided about each conversation information.

The chatting server inspects whether or not the chatting message received through the step 412 is the general conversation information or the whisper information in step 414.

When the corresponding chatting message is whisper, the chatting server searches for user connected to the corresponding chat room and transmits the corresponding conversation information to the searched the user terminal in step 418.

Also, when the corresponding chatting message is not the whisper information, the chatting server searches for all user(it includes the user inputting the chatting message) connected to the corresponding ‘chat rooms’ and transmits the corresponding conversation information to a plurality of the searched user terminals .

The user terminal(that is, the user terminal can mean the chatting program processed in the user terminal) outputs the conversation information received through the step 418 or the step 416 on the screen of the user terminal in step 420.

The user terminal(that is, the chatting program) inspects whether or not the user finishes the chatting in step 422.

The method to confirm whether or not user finishes chatting in the step 422 is able to apply to the method that the corresponding user confirms the end request of the chatting program(for example, chatting applet) or method to recognize the end of chatting when the user doesn't input the chatting message for definite time(for example, 30 minutes)

when the user doesn't finish chatting, the central server waits until the user inputs the chatting message in the step 410.

Also, when the user finishes the chatting program in the inspection result of the step 422, the step is ended.

FIG. 5 is a flow chart illustrating the synchronization of the chatting information and the real time information in accordance with another preferred embodiment of the present invention.

Referring to FIG. 5, the user to want chatting connects the chatting server and performs login to input user ID and Password in the step 500.

The chatting server confirms whether or not the input user ID and Password are suitable contents for chatting.

when the input contents are suitable for chatting, processes to step 506. And when the input contents are not suitable for chatting, the user processes and performs registration of the membership in step 504.

The step 504 may include to display an alarm message ‘it is not member’ on the screen or to move to the page of the registration of the membership.

The registered matter is stored in the storage device of a member information server, processes to the step 502 to input user ID and password again.

When the input information is suitable contents for chatting in the step of 506, the chatting server confirms whether or not it changes environment setting information of the real-time information list to want the user to be provided. The confirmation step for the change of environment setting of the real-time information list may apply to icon or hyperlink displayed on the screen.

When it doesn't change the environment setting in step 512, the basic real-time information is displayed and simultaneously the chatting server is activated.

The basic real-time information includes the information to be provided generally in case of a new user and the information to be the suitable environment setting changed existing in case of the existing user.

Multiple frames composed of the real time information and the chatting screen activated by the chatting server is displayed simultaneously on one screen.

The real-time information server confirms in the step 514 whether or not the new information corresponding to the real-time information list establishing the user renews existing information.

When the new information doesn't renew, the real-time information server processes to the step 512 repeatedly till existing corresponding to information

When the new information renews, the information in the real-time information area is renewed in step 516. Also, when the user changes setting of the real-time information list in step 508, the changed matter is stored in environment setting storage device of the real-time information list. The real-time information corresponding to the changed information list is displayed in information area in step 510 and activated the chatting server simultaneously. The chatting server receives the chatting message from at least one selected from the group of the users in step 518.

The chatting message that the chatting server receives through the step 518 may be the chatting message(that is, the CHATTING CONTROL COMMAND) to chat or the chatting message(that is, the CONTENTS CONTROL COMMAND) to request the real-time information.

And, the CONTENTS CONTROL COMMAND may be organized into various types.

(1) the CONTENTS CONTROL COMMAND(that is, USER TYPE APPOINTMENT COMMAND-hereinafter referred to form ‘/Samsung electronic’). established providing the corresponding real-time information for only user requesting the corresponding real-time information, the CONTENTS CONTROL COMMAND(that is, USER TYPE APPOINTMENT COMMAND-hereinafter referred to form ‘=Samsung electronic’) established providing the corresponding real-time information for all user connected to corresponding ‘chat room’, the CONTENTS CONTROL COMMAND(that is, USER TYPE APPOINTMENT COMMAND-hereinafter referred to form ‘%Samsung electronic’) established providing the corresponding real-time information for user except user requesting the corresponding real-time information.

Also, when a special user(user to have identification of estorm) inputs and transmits the chatting message of form ‘/32680’ , the central server recognize the message in order to request the real-time information about the special item based on the special symbol ‘/’ among the received chatting messages. And the central server searches the real-time information about the item corresponding to ‘32680’. and outputs in the chatting message output area or in a special window or the real-time information provision area.

For example, When the real-time information request input thorough chat window area is ‘/32680’, form of the chatting message received to the chatting server is ‘##CODE##estorm#32680#$2’. That is, it is received by the form of ‘[##CODE##][sender]$2[corresponding code of special item]#$2[letter color]’

The central server inspects in step 520 whether or not the chatting message received through the step 518 is the CONTENTS CONTROL COMMAND including USER TYPE APPOINTMENT COMMAND.

When the chatting message is not the CONTENTS CONTROL COMMAND in order to request the real-time information (that is, in case of CHATTING CONTROL COMMAND to process chatting), the central server processes the chatting service in step 522, otherwise processes to step 524.

That is, the central server distinguishes the CHATTING CONTROL COMMAND is composed of the form of the letters from CONTENTS CONTROL COMMAND to request the real-time information including the identification symbol(for example, /, =,% etc).

The step 522 means the step to perform operating corresponding to the CHATTING CONTROL COMMAND of the whisper or the general chatting.

The central server inspects in the step 524 whether or not the chatting message received through the step 518 is CONTENTS CONTROL COMMAND (that is, USER TYPE APPOINTMENT COMMAND) to appoint object for providing real-time information.

That is, the central server judges that the user requests the real-time information without appointing to a object when the user named hong-gil-dong requests the real-time information by form of ‘=Samsung electric’. When the user requests the real-time information by form of ‘/Samsung electric’ or ‘%Samsung electric’, the central server judges that the user requests the real-time information with appointing to the object.

When the chatting message is the CONTENTS CONTROL COMMAND to appoint to an object to inspection result of the step 524, the central server processes to step 526 and when not the central server processes to step 532.

The central server searches for real-time information corresponding to the item requested by the user among the real-time information received from information providing server(130) and stored in the storage device in the step 526.

When the user named hong-gil-dong requests the real-time information by form of ‘/Samsung electric’ or ‘% Samsung electric’, the central server searches for the real-time information about ‘Samsung electric’ (for example, the present price, a transaction quantity, kosdaq 80, KOSPI200)

Of course, when the user appoints a kind of the corresponding real-time information(that is, in case of inputting contents type command), the only appointed information may be output on the user terminal.

That is, when the corresponding real-time information is the stock quotation, information that the user wants is the daily chart and the identification code named daily chart is appointed ‘G’, the user can receive the daily chart by means of inputting the identification code-named ‘G’ among the CONTENTS CONTROL COMMANDs.

And, the user unknown identification code can obtain the same result by means of inputting an English term corresponding to ‘daily chart’ in English or inputting daily chart by means of hangul.

Also, such method can be applied to the similar all area of essential stock quotation without being limited to the daily chart.

In accordance with another preferred embodiment of the present invention, the server can provide the corresponding information according to the input information that the user classifies the information like ‘/32680-1’ or ‘/32680-2’ in chat window.

For example, the selected information is the current price information with the ‘−1’, the selected information is the transaction quantity with the ‘−2’, and the selected information is the daily chart with the ‘−3’. And then the server decreases the load because the quantity of the information provided from the server is controlled.

Also, the user can peruse the real-time code information without inputting the form of the special symbol, the special code and selection information by making use of selection item included in the chat window.

The central server searches for the appointed target for user to provide the real-time information in the step 524.

When the user named hong-gil-dong requests the real-time information by the form of ‘/Samsung electric’, the central server searches for communication information (for example, connected IP address etc) of the user named hong-gil-dong in order to provide the corresponding real-time information.

Also, when the user named hong-gil-dong requests the real-time information by the form of ‘%Samsung electric’, the central server searches for the communication information (for example, connected IP address etc) of the user except hong-gil-dong(that is, the user named sung-chun-hang, hyung-bu) to provide corresponding real-time information.

Also, the target to provide the real-time information can be searched through the synchronous information.

The synchronization information is the information to hold the provided real time information requested from the user and a plurality of other users selected by the user.

For example, the form of the conversation information including synchronization is received by the form of ‘[##SYNCH##][sender]#$1[receiver]#$1[synchronous contents]’. The synchronization of contents can be presented ‘share’ in case of ‘information share’ and ‘reject’ in case of ‘information rejection’.

The central server transmits the corresponding real-time information about the corresponding item searched through the step 526 to the target using the communication information of the searched target.

Also, in case of appointing for user to the special information as explain for the step 526, the central server can transmit only appointed information to the corresponding user.

Referring to the step 524 again, when the chatting message received through the step 518 is the CONTENTS CONTROL COMMAND without appointing to the target, the central server processes to the step 532.

That is, it means that the user named hong-gil-dong requests the real-time information by form ‘=samsung electric’.

Also, in case of appointing for user to the special information as explain for the step 526, the central server can transmit only appointed information to the corresponding user.

The central server searches for the real-time information(the corresponding information in case of appointing the contents type) corresponding to item requested by the user in the storage device in the step 532, the corresponding user searches for all user connected to the ‘chat room’ that the corresponding connect, processing to the step 534 and transmits the corresponding real-time information to corresponding user through the 530.

The method to be provided the real-time information distinguishably through FIG. 5 can apply to all information(for example, a internet broadcasting, news, sports news etc)to be able to be provided in the real-time information area.

That is, For example, let's explain the internet broadcasting output in the real time information provision area and a plurality of internet broadcasting established a channel form(for example, maekyung TV-CH1, WOW TV-CH2 etc)

In case of presenting ‘wow TV’ in the real-time information provision area of the current special user, the user can change the corresponding internet broadcasting channel into form of ‘/CH1’, ‘%CH1’, ‘=CH1’.

The central server can present the same broadcasting to the other user or change the channel by only corresponding user according to each identification symbol(that is, %, /, =etc).

Also, such concept can apply to similarly about the output information about the real-time news.

That is, when the real-time news about football in the current real-time information provision area is provided and the special user want to peruse a major game result to take the mound for Park-chan-ho, the user can be provided or can provide information to want for the other user by form of ‘/ Park-chan-ho+game result’, ‘% Park-chan-ho+game result’, ‘=Park-chan-ho+game result’

Also, when the user inputs internet broadcasting channel change request while presentation of sports news, the user terminal can be presented internet broadcasting of the corresponding channel instead of sports news.

The user can use form of a telelecture, a audiovisual lecture and teleconference using function to hold in common the special information with at least one of user.

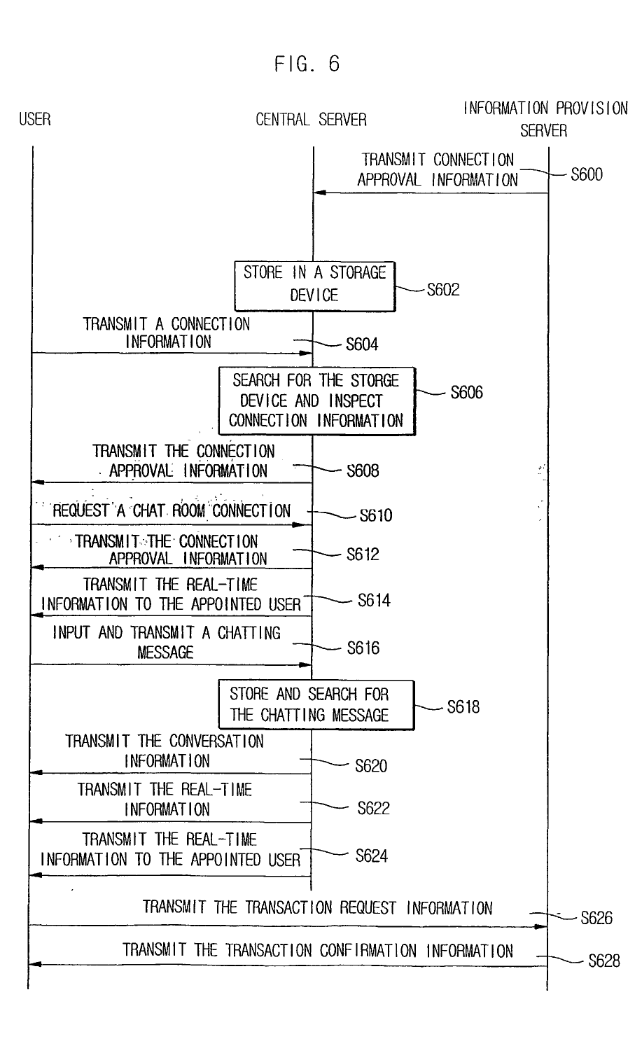

FIG. 6 is a flow chart illustrating the synchronization of the chatting information and the real time information in accordance with another preferred embodiment of the present invention.

The FIG. 6 present a data flows among the user terminal, the central server and a information-provision server.

Referring to FIG. 6, the central server receives information(for example, a stock, a present, a option)in real time from the information-providing server in step 600. The step 600 is processed in real time or in repeated whenever the new information is renewed in the information-provision server.

The central server stores the real-time information received in the step 600 in the storage device of the central server in step 602.

Hereinafter, the central server receives the connection information including the ID and password from the user terminal connected with the communications network in step 604.

The central server inspects whether or not the connection information received in the step 604 is valid in step 606 by means of the method for searching the storage device.

The storage device applying in the step 606 can be used to a plurality of storage device group that comprises the member information storage device to store the member information, a environment setting storage device of the real-time information list to store information list that user want to be provided, a real-time information storage device to store the real-time data to change in real time on web.

When the connection information is confirmed as the valid connection information through the step 606, the central server transmits the connection approval information through the communications network to the user terminal in step 608.

A plurality of chatting area including the real-time information corresponding to the appointed information item that the user wants to be provided for through step 608 is displayed on the screen of the user terminal.

The central server receives selection information for the special ‘chat room’ among a plurality of chat areas(for example, a kosdaq ‘chat room’, a Samsung electric ‘chat room’ etc) displayed on the screen of the user terminal in step 610.

The central server can transmit the connection approval information about the connection request to the chatting area based on the received through the step 610, and simultaneously adding the real-time information that the user wants to be provided in the step 614 using the communications network.

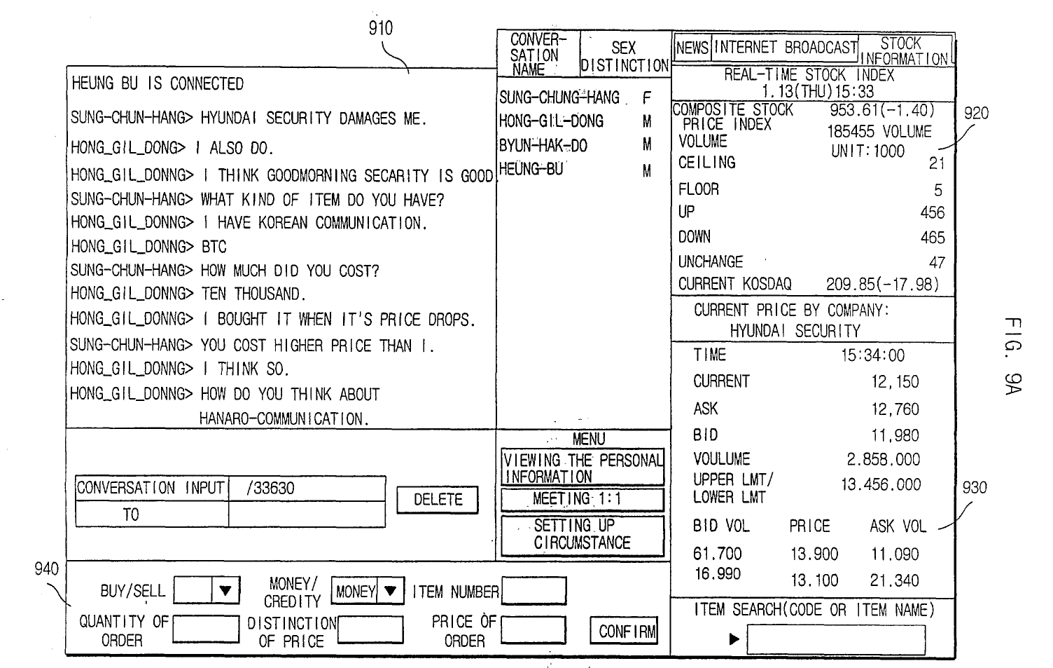

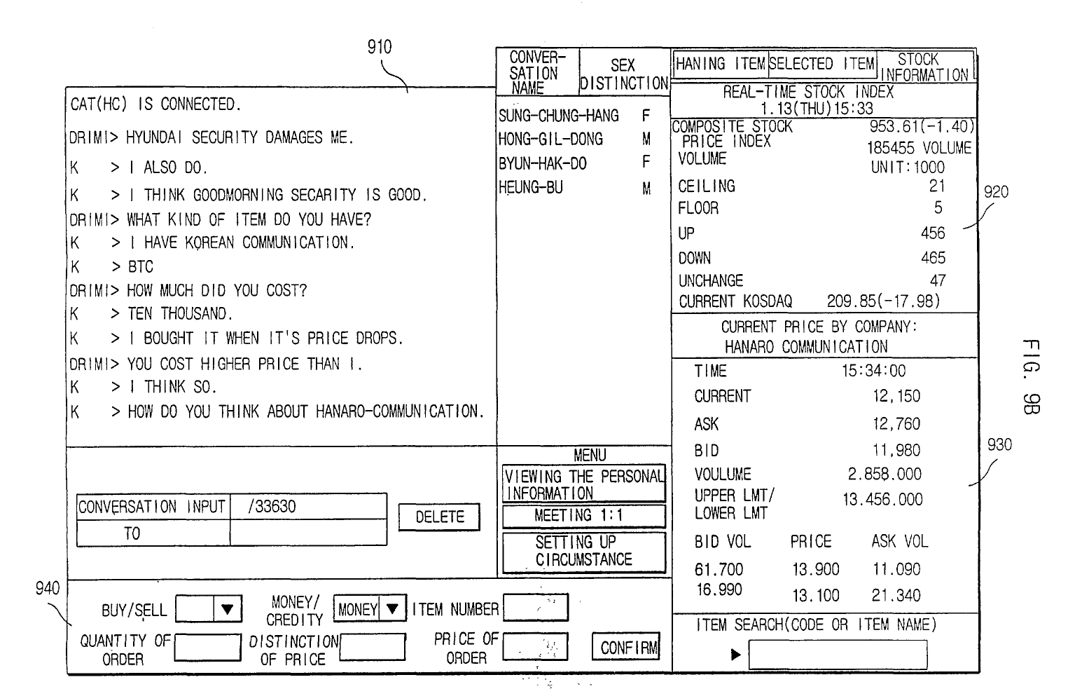

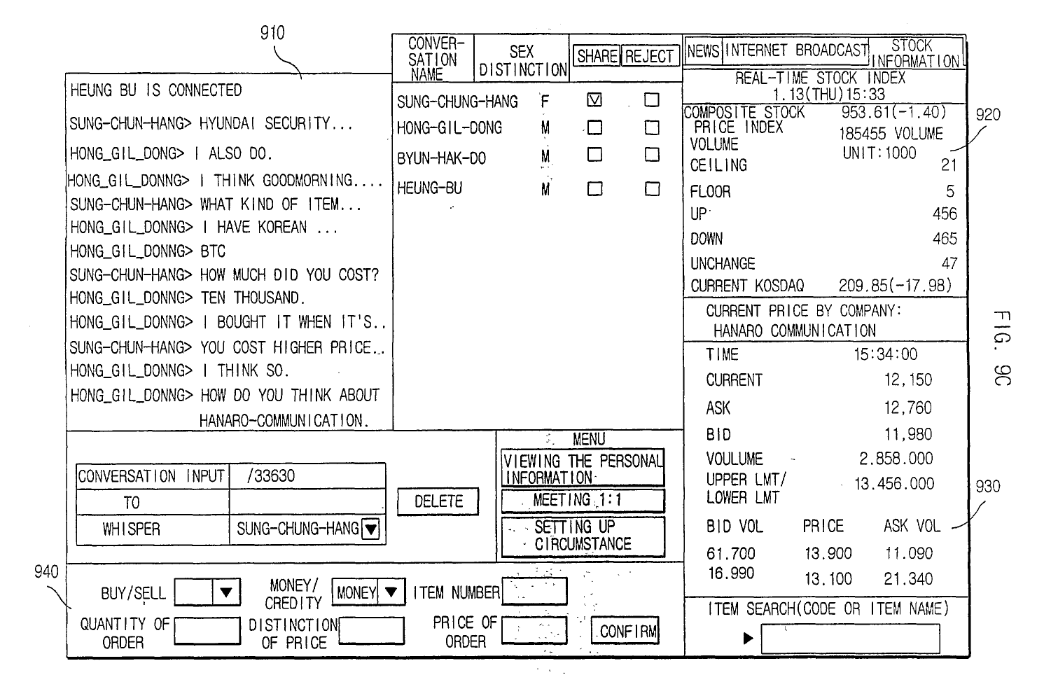

An information form to be provided to the user terminal using the communications network in the step 612 and the step 614 is displayed on the screen of the user terminal as FIG. 9a. Hereinafter, explain in detail referring to FIG. 9a.

Hereinafter, the user is able to chat with a plurality of users using the chatting area displayed on the screen.

The central server receives the chatting message to be transmitted and input from a plurality of user terminals in step 616.

The central server stores the chatting message received in the step 616, and confirms whether or not the chatting message include the CONTENTS CONTROL COMMAND information about the special item.

Also, the central server can further include the step to abstract the real-time information about the corresponding item by means of searching for the storage device based on inspection result in step 618 or to receive the corresponding information requesting the real-time information of the corresponding item to the information-provision server.

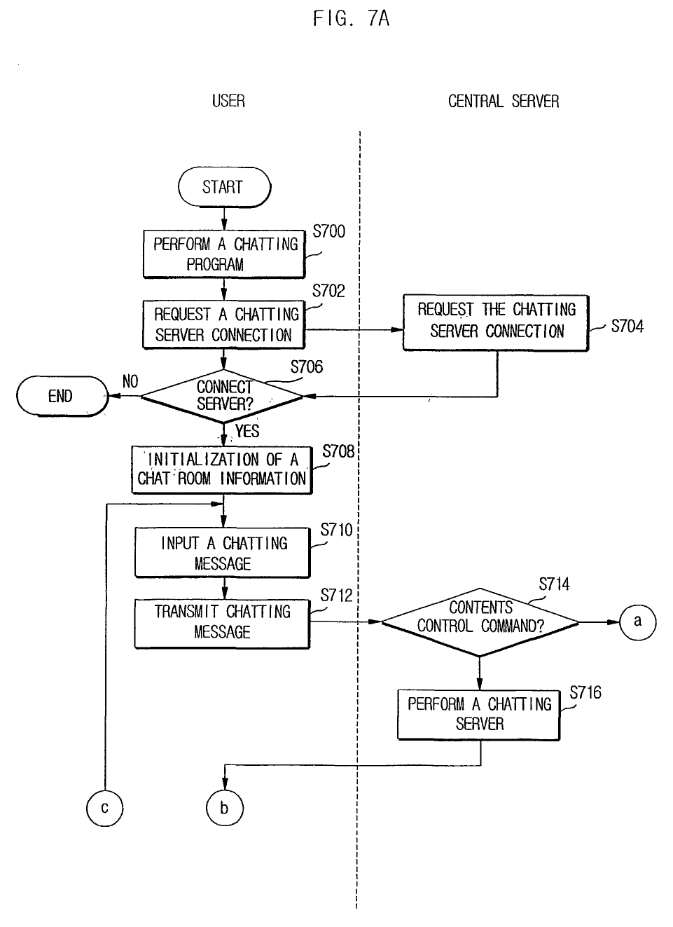

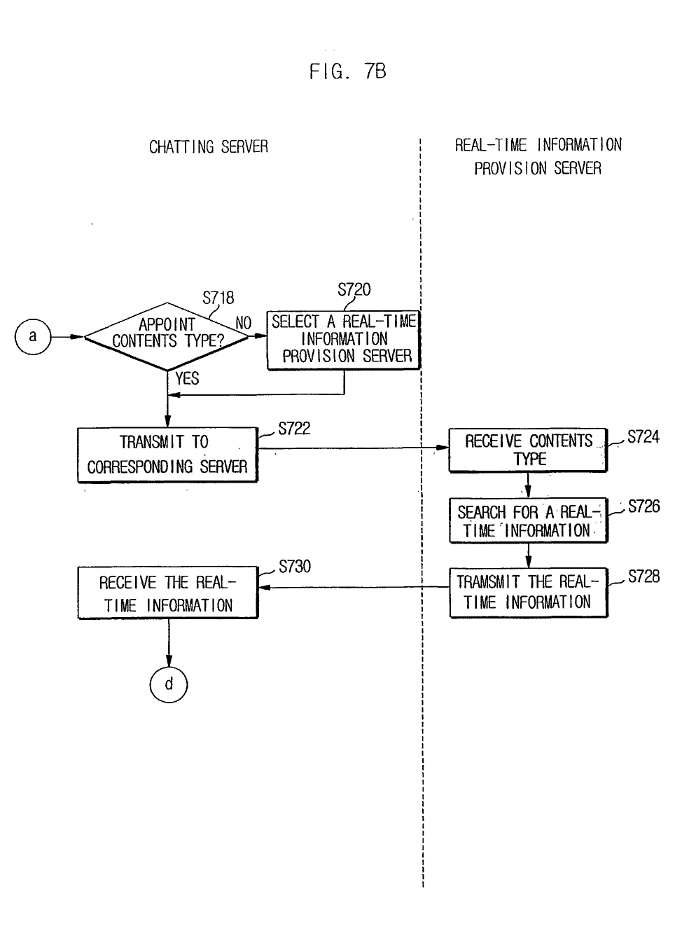

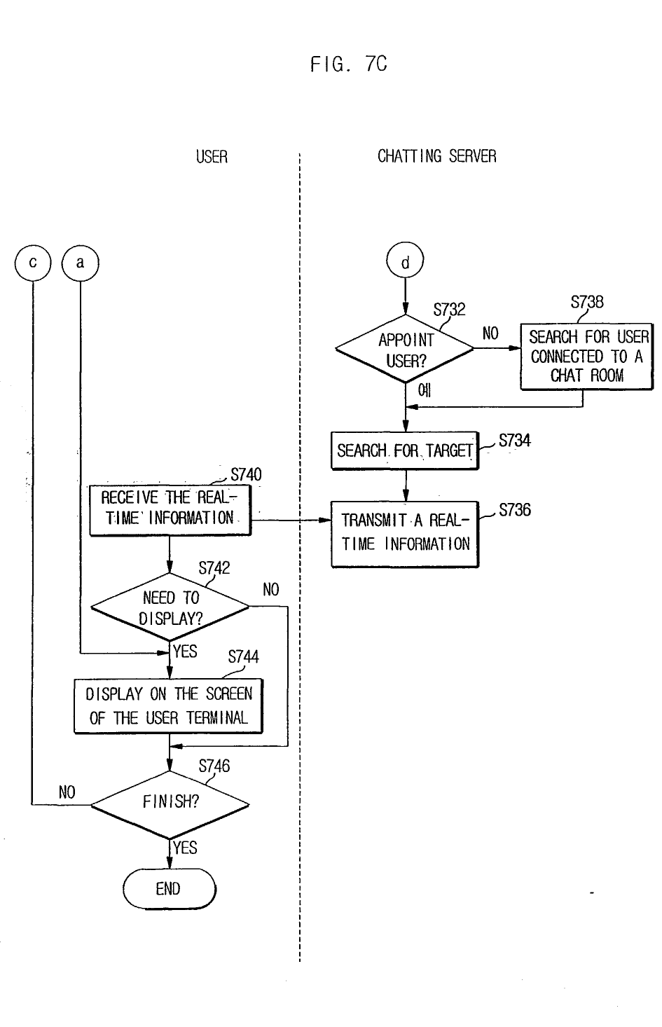

The CONTENTS CONTROL COMMAND information inspection of the corresponding item in the step 618 explains in detail referring to FIG. 7.

Hereinafter, in step 620 the central server transmits the chatting message received in the step 616 and the real-time information abstracted for inspection of the step 618 to a plurality of the users(for example, a plurality of the users connecting in the same chat area).

Also, after inspecting the storage device repeatedly, confirming renewal of the real time information, when the real time information exists, the center server transmits the real time information to the user terminal while chatting. In step 626, the user decides whether transaction about a special item information is or not based on the real-time information for step 622 and step 624. When the user input the transaction information on the same screen in case of deciding transaction, the transaction request information of the user is transmitted to the transaction server in real time. That is, the transaction request information input for the user transmits to the web site processing the stock transaction by the transaction server. So screen displayed the user terminal is including link for the web site.

A special user can process the transaction in real time using the step 626 without calling at the corresponding company homepage for the transaction of special item or requesting transaction by telephone or calling at the corresponding company.

The transaction server receiving transaction request information for the step 626 process the corresponding transaction, thereinafter transmits the performance result to the corresponding user terminal for the communications network in step 628.

FIG. 7 is a flow chart illustrating for providing chatting service and contents on the communications network in accordance with another preferred embodiment of the present invention.

Referring to FIG. 7, the user terminal processes the chatting program received from the chatting server in step 700.

When the chatting program(for example, the chatting applet etc)is processed for the step 700, the user terminal transmits to the chatting server(it may be the chatting server constituted one or the special server in case of constituting to a plurality of real-time information-provision server except the chatting server)the connection request information for the chatting program itself operation.

The chatting server(it may be a special server in case of comprising a plurality of real-time information-provision server but the following called the chatting server for convenience of explanation) transmits a initialization information for corresponding ‘chat rooms’ connection based on chatting server connection request transmitted for step 702.

The user terminal inspects whether it connect to the chatting server or not in step 706. by using the receiving initialization information

When the user terminal is connected the chatting server for inspection result of the step 706, it processes to step 708 and when not the step is ended.

Also, when the user terminal is not connected the chatting server for inspection result of the step 706, the user terminal can perform repeatedly the step to transmit connection request to the chatting server, processing to the step 700 again.

The chatting program established the user terminal is initialized the ‘chat rooms’ information using the initialization information received for the step 704 and the step 706 in the step 708.

When the ‘chat room’ information is initialized for the step 708, the user terminal display area is displayed at least one of chatting message input area(for example, the whisper input area, the chatting message input area)for the user to be able to input chatting message and a chatting message display area

The chatting program is input the chatting message from the user in step 710 and transmits to the chatting server the corresponding chatting message for the communications network, processing to step 712.

The step transmitting to the chatting server the chatting message for the step 712 may include the step inserting each independent message folder according to use of the corresponding chatting message.

That is, when the corresponding chatting message includes the USER TYPE APPOINTMENT COMMAND or the CONTENTS TYPE APPOINTMENT COMMAND, the chatting server can insert the message folder to be appointed independently corresponding to the corresponding command.

In case of inserting the described message folder, the chatting server receives the corresponding chatting message and then the chatting server may be performed work requested by the corresponding chatting message not performing a special chatting message change work.

The chatting server inspects in the step 714 whether the chatting message received for the step 712 is the CONTENTS CONTROL COMMAND or not.

When the chatting message is not the CONTENTS CONTROL COMMAND received for the step 712 for the inspection result of the step 714, the chatting server performs the chatting service processing to the step 716 and then processes to the step 710.

Of course, when the chatting message is not the CONTENTS CONTROL COMMAND but the CHATTING CONTROL COMMAND for the inspection result of the step 714, the chatting server transmits the corresponding chatting message to a plurality of user and then the corresponding chatting message is displayed on the corresponding user terminal display screen.

Also, when the corresponding chatting message is not the CONTENTS CONTROL COMMAND but the whisper for the inspection result of the step 714, the chatting server transmit the corresponding chatting message to only suitable user. the more concrete explanation refers to FIG. 4

Also, in case of the chatting message received for the step 712 is the CONTENTS CONTROL COMMAND for inspection result of the step 714, the chatting server processes to step 718.

The chatting server inspects in the step 718 whether the chatting message (that is, CONTENTS CONTROL COMMAND)received for the step 712 is the CONTENTS TYPE APPOINTMENT COMMAND or not.

The CONTENTS TYPE APPOINTMENT COMMAND to appoint a kind of a real-time information for the user to want to be provided can apply to appoint method to appoint constituting a special identification symbol every kind of each the real-time information.

That is, the CONTENTS TYPE APPOINTMENT COMMAND is to apply to ‘G’ called daily chart and ‘P’ called the current price. In case of the chatting server receiving the chatting message called ‘/P 05930’ from the user, the chatting server can recognize automatically that the user want to ‘P(that is, the current price information)’ of the item code 05930(that is Samsung electric).

Also, the CONTENT TYPE APPOINTMENT COMMAND may apply to a plurality of identification code at a time. That is, in case of the user inputting the CONTENTS TYPE APPOINTMENT COMMAND by form of ‘/P+G 05930’, the user can be provided along with the current price information and the daily chart of the samsung electric simultaneously.

The CONTENTS TYPE APPOINTMENT COMMAND can apply to the current price information called ‘−1’ and the daily chart called ‘−3’ in accordance with another preferred embodiment of the present invention

For example, when the chatting server receives the chatting message called ‘/05930-1’ from the user, the chatting server can recognize that the user want to ‘−1(that is, the current price information)’ of the item code 05930(that is, Samsung electric).

When the chatting server receives the CONTENTS TYPE APPOINTMENT COMMAND from the user by the inspection result of the step 718, the chatting server selects a suitable real-time information-provision server to perform the corresponding CONTENTS TYPE APPOINTMENT COMMAND processing to the step 720 and then process to step 722.when the chatting server doesn't receive the CONTENTS TYPE APPOINTMENT COMMAND from the user by the inspection result of the step 718, the chatting server process directly to the step 722 recognizing that the user request synthetic information(that is, all information to be able to be provided).

The chatting server transmits the chatting message(that is, the CONTENTS TYPE APPOINTMENT COMMAND) received for the step 712 to the real-time information-provision server selected for the step 718 or the step 720 in the step 722.

The real-time information-provision server receives the chatting message(that is, CONTENTS TYPE APPOINTMENT COMMAND)transmitted for the step 722 and searches the real-time information corresponding to the CONTENTS TYPE APPOINTMENT COMMAND processing to the step 726.

The real-time information-provision server transmits to the chatting server the real-time information searched for the step 726 in the step 728.

The flow chart illustrated FIG. 7 illustrates as the step 724 and the step 728 perform in the one real-time information-provision server but, when the user requests many the real-time information simultaneously for the CONTENTS TYPE APPOINTMENT COMMAND as explanation previously, the step 724 and the step 728 is performed in many the real-time server simultaneously.

The chatting server receives the real-time information to be transmitted for the step 728 in step 730 and inspects whether the user to transmit the corresponding real-time information for the step 730 is appointed in the chatting message or not.

Let's omit explanation about above-mentioned method to appoint the user holding the corresponding information in common for the chatting.

When the chatting message received from the user includes the USER TYPE APPOINTMENT COMMAND (that is, the CONTENTS CONTROL COMMAND appointing target) for the inspection result of step 732, the chatting server process to step 734 and when not, the chatting server processes to step 738.

The chatting server searches a target appointing to the user using the CONTENTS CONTROL COMMAND in the step 734.

The method to search for target to transmit the corresponding real-time information may use the identification code to be comprised in the CONTENTS CONTROL COMMAND as explain previously in the step 734.

In step 736, the chatting server transmits the real-time information received for the step 730 to the user searched for the step 734 and then process to the step 738.

Referring to the step 732 again, when the corresponding CONTENTS CONTROL COMMAND is provided to all user to be connected the same ‘chat room’ not appointing a special target, the chatting server searches for all user to be connected the same ‘chat room’ processing to the step 738 and then transmits the corresponding real-time information processing to the step 736 and processes to step 740.

The chatting program receives the real-time information and then the CONTENTS CONTROL COMMAND transmitted for the step 736 in the step 740.

In step 742 the chatting program inspects whether the corresponding real-time information need to display at the user terminal or not using the CONTENTS CONTROL COMMAND (that is, USER TYPE APPOINTMENT COMMAND) received for the step 740

When the corresponding real-time information needs to display for the user terminal for the inspection result of the step 742, the corresponding real-time information is displayed on the user terminal display screen and then process to step 746.

Also, when the corresponding real-time information doesn't need to display for the user terminal to the inspection result of the step 742, the chatting server processes to the step 746 directly.

The method that the chatting program established in the user terminal inspects whether the real-time information transmitted from the chatting server needs to display make use of message folder inserted based on identification code to be comprised in the chatting message or corresponding identification code

That is, when the chatting message is input by form of ‘/samsung electric’, the chatting server operates not to display the corresponding chatting message on the other user terminal display screen of other user not inputting the corresponding chatting message. Also, when the chatting message is input by form of ‘=samsung electric’, the chatting server operates to display the corresponding chatting message on the user terminal display screen of all user connecting the same ‘chat room’.

The chatting program inspects in the step 746 whether a chatting ending command is input from the user or not. When the chatting ending command is input, the step is ended; otherwise the step 700 is processed again to perform continuously the chatting service.

According to another preferred embodiment of the present invention, when the chatting server transmits to the user terminal only URL position information of the corresponding real-time information for processing rapidly providing of the real-time information, it is provided a system and method for providing chatting service and contents to be able to display on the user terminal display screen receiving automatically The corresponding real-time information Connecting to the corresponding URL The chatting program established the user terminal.

At this time, for outputting the corresponding real time information in step 744 of flow chat illustrated FIG. 7 further comprises the step that chatting program connects real time information-provision server and receive the corresponding information form the corresponding real time providing server.

According to another preferred embodiment of the present invention, it is provided a system and method for providing chatting service and contents on the communications network to able to transmit real time information to the user terminal directly without being via chatting server for making up for demerit of a heavy load of the chatting service by being transmitted and received real time information for the chatting server. At this time, the step 730 and 740 can delete in the flow chat illustrated FIG. 7, the step for the chatting server decreases, the chatting server processes the chatting service smoothly.

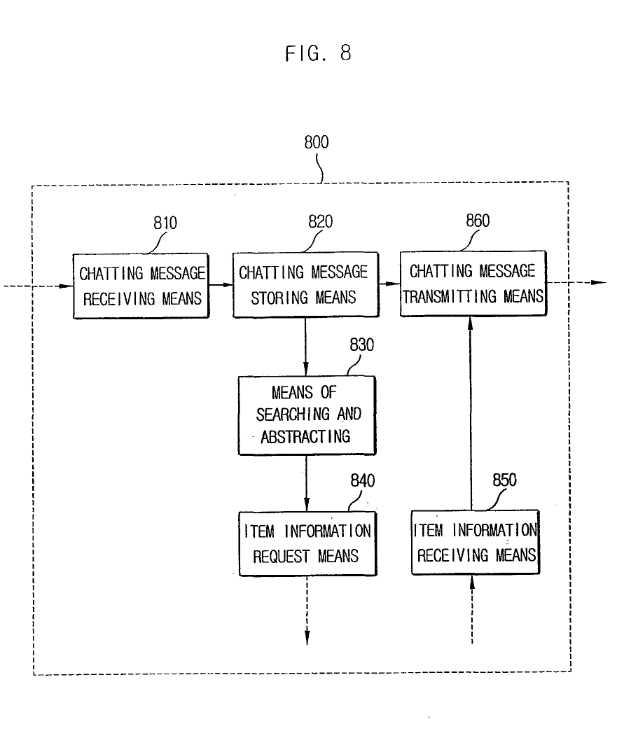

FIG. 8 is a flow chart illustrating for providing real time information for chatting information in accordance with one preferred embodiment of the present invention.

The FIG. 8 presents constitution of the central server to provide the real-time information of related special item using the chatting information to process for a plurality of user.

Referring to FIG. 8, the management server(800) comprises a chatting message receiving means(810), a chatting message storing means(820), a means of searching and abstracting of the CONTENTS CONTROL COMMAND information(830), a item information requesting means(840), a item information receiving means(850), a chatting message transmitting means(860).

The chatting message to transmit for a plurality of user inputting is received in the chatting message receiving means(810) and the received chatting message is stored in the chatting message storing means(820)

The chatting message storing means may be constituted of buffer. The buffer is the storage device to store temporary the information and specially is means to be used during waiting operation the slow system component

The chatting message stored in the chatting message storing means(820) is transmitted to means of searching and abstracting of the CONTENTS CONTROL COMMAND information(830) and the chatting message transmitting means(860).

The means of searching and abstracting of the CONTENTS CONTROL COMMAND information(830) inspects whether the received chatting message comprise the CONTENTS CONTROL COMMAND information presenting a special item or not. In case of the corresponding CONTENTS CONTROL COMMAND information being, The means of searching and abstracting of the CONTENTS CONTROL COMMAND information(830) searches the CONTENTS CONTROL COMMAND information and then transmits to the item information request means(840) The CONTENTS CONTROL COMMAND information can apply to the special item name(for example, Samsung electric etc) and code(for example, A09830 etc).

The item information requesting means(840) requests the real-time information of corresponding item to the real-time information-provision server based on special item information received from the means of searching and abstracting of the CONTENTS CONTROL COMMAND information(830).

And, the real-time information related the special item to be transmitted from the real-time information-provision server by the request the item information requesting means(840) is received for the item information receiving means(850).

Also, the item information receiving means(850) transmits to the chatting message transmitting means(860) the received real-time information. And the chatting message transmitting means(860) transmits to a plurality of user terminal participating in chatting in the same ‘chat room’ using by the communications network the chatting message received from the chatting message storing means and the real-time information received from the item information receiving means(850).

When it is not the information related the special item searching the received chatting message in the chatting message storage at the means of searching and abstracting of the CONTENTS CONTROL COMMAND information(830), the only conversation information corresponding to the received CHATTING CONTROL COMMAND information for the chatting message transmitting means(860) is transmitted to a plurality of user terminal.

FIG. 9a and FIG. 9b are illustrations of the synchronization of chatting information and real time information in accordance with one preferred embodiment of the present invention.

It explains about method to provide the real-time information for the user to request limiting in the real-time information providing area referring to FIG. 9a and FIG. 9b. in case of the corresponding real-time information appointing the contents type and in case of outputting for the chatting area is concrete explain referring to other figure hereinafter.

Referring to FIG. 9a, the screen presented the chatting information and synchronization of the real-time information can include the chatting area(910), the real-time information providing area(that is, the real-time stock index providing area)(920), the individual item index area(930), the transaction area(940) etc.

The chatting area(910) can include the chatting message display area to be output the chatting situation processing among a plurality of user, the chatting message input area to be able to input for the user the chatting message, area to perusal a plurality of user information and menu area.

The real-time stock index providing area(920) is area to be able to output the stock situation in general not limiting a special item. The individual item index area(930) is area to be able to output the detail information for item requesting for the item search area comprised in the individual item index area(930) or to request for the chatting area(910).

The transaction area(940) is area that the user can accomplish the transaction about the special item in real time by inputting the corresponding information and selecting the information icon, when the user decides the transaction related with a special item for the chatting field(910), the real time stock index providing area(920) and the individual item index area(930)

The transaction area(940) doesn't constitute to be displayed on the same screen with the real-time stock index providing area(920), individual item index area(930) and constitute only ‘transaction’ icon. And then, in case of the special user selecting ‘transaction’ icon, the transaction area(940) can apply to be constituted a separate window.

The following, referring to FIG. 9a and FIG. 9b, let's concrete explain about the present invention. for the convenience of explanation, it explains an example that four user named hong-gil-dong, sung-chun-hang, byun-hak-do, hyung-bu process the chatting.

Referring to FIG. 9a, the chatting area(910) can include the chatting message display area to be presented the chatting situation to be processed among a plurality of user, the chatting message input area to be able to input for the user the chatting message, the user information(for example, a conversation name, sex distinction) providing area to connect the corresponding ‘chat room’ simultaneously, a selection menu(for example, personal information seeing, 1:1 meeting, environment setting etc)area.

When the user named hong-gil-dong input the chatting message called ‘bang-ga bang-ga’ using the chatting message input area and select enter key etc, the corresponding chatting message is displayed in the same way in the chatting message display area output on the user computer screen of hong-gil-dong, sung-chun-hang, byun-hak-do connecting the same ‘chat room’. A plurality of user processes the chatting by performing the described operation repeatedly and successively.

And, the user can be provided the information about item to want by inputting the item name of special item or the item code for the item searching area comprised in the individual item index area(930) during chatting.

Also, the real-time stock index can be provided to the user the rapid stock information changing automatically continuously without the request from the user during chatting among a plurality of user.

At this time, when the central server consists of the chatting server performing the chatting service, and the real time information server providing the real time information separately, the central server can look forward to improvement of work process totally, because the chatting area(910) and the real time information providing area(that is, the real time stock index providing field(920), the individual item index field(930)) can perform work by being connected with each independent server.

But, being provided for user to the real-time information for the described method may be caused inconvenience to be provided the real-time information only by moving the cursor position in the chatting message input area to the item search area using the tap button or the mouse

According to, the present invention can be applied to method to be able to control the real-time information providing area for processing work of the user for the chatting area(910)

The present, the screen display described FIG. 9a is output the real-time information about the current stock inter the individual item index area(930).

At this time, the special user can be provided the real-time about item to want inputting the identification symbol(for example, /, =, % etc) , item name or item code in the chatting message input area.

When the central server consists of a plurality of server, the central server performs operation transmitting the chatting message received from the chatting server to the real-time information server

At this time, a method to request to be provided the real-time information can be regard for the various methods.

First of all, one method is to provide the corresponding real-time information only the user to request the corresponding real-time information.

When the user named hong-gil-dong requests the real-time information inputting ‘/ hanaro communication’ or ‘/33630(that is, item code of hanaro communication), the computer screen of the user named hong-gil-dong is output on screen display like FIG. 9b comprising the real-time information for ‘hanaro communication’

That is, it is that the real-time information output in the individual item index area(930) by request of the user named hong-gil-dong is changed from the real-time information about ‘hyundai stock’ into the real-time information about ‘hanaro communication’

Also, at this time the computer screen of other user(that is, sung-chung-hang, byun-hak-do, hyung-bu etc)is displayed screen display(in case of the corresponding user requesting other information, outputting different)as FIG. 9a not outputting screen display as FIG. 9b.

Next, one method is to provide the corresponding real-time information all user connecting the corresponding ‘chat room’.

When the user named hong-gil-dong requests the real-time information by inputting ‘=hanaro communication’ or ‘=33630(that is, item code of hanaro communication), the computer screen of the user named hong-gil-dong is output on screen display like FIG. 9b comprising the real-time information for ‘hanaro communication’

That is, it is that the real-time information output in the individual item index area(930) for request of the user named hong-gil-dong is changed from the real-time about ‘hyundai stock’ into the real-time information about ‘hanaro communication’

Also, at this time the computer screen of other user(that is, sung-chung-hang, byun-hak-do, hyung-bu etc)is displayed the real-time information output in the individual item index area(930)of hong-gil-dong in the same way.

Such method may make use of method(for example, telelecture)to hold the same information with the other user in common and accomplish common object for the special user holding in common the same information with the other user.

Next, one method is to provide the corresponding real-time information only other user except to the user to request the corresponding real-time information.

When the user named hong-gil-dong request the real-time information by inputting ‘% hanaro communication’ or ‘%33630(that is, item code of hanaro communication), the computer screen of the user named hong-gil-dong is continued the real-time information situation about ‘hyundai stock’ but the computer screen of other user is output on screen display like FIG. 9b.

That is, the real time information about ‘hyundai stock’ is changed into the real time information about ‘hanaro communication’ and the real time information about ‘hanaro communication’ outputs only on the computer screen by the request from the user. Also, in addition to the described method, method to control various information(for example, internet broadcasting, news) provided for the real time information providing area as well as method to provide the same real time information to the entire user except the special user, can be applied.

Referring to FIG. 8 and FIG. 9a and FIG. 9b again, it explains being connected the chatting and the real-time information.

It explains an example that the chatting is processed for a plurality of user and the user named ‘hong-gil-dong’ transmits inputting the conversation information ‘Do you looks like to rise the hanaro-communication?

Referring to FIG. 8 again, the conversation information of ‘Do you looks like to rise the hanaro-communication? Is received for the chatting message receiving means(810) and then is transmitted to the chatting message storing means(820).

The following, the chatting message storing means(820) transmits the chatting message called ‘Do you looks like to rise the hanaro-communication? to the CONTENTS CONTROL COMMAND information searching and search searching means(830) and the chatting message transmitting means(860)

The CONTENTS CONTROL COMMAND information searching and search searching means(830) inspects whether the received conversation information called ‘Do you looks like to rise the hanaro-communication? Comprises information about the special item or not and then abstracts the item name called ‘hanaro-communication’.

And, the abstracted item name called ‘hanaro-communication’ is transmitted to the item information request means(840) and the item information request means(840) transmits the request information of the real-time information for the item name to the information-providing server.

The following, the information-providing server transmits the corresponding information in real time to the item information receiving means(850) using by the communications network searching storage device.

The item information receiving means(850) transmits the real-time information about the received ‘hanaro-communication’ to the chatting message transmitting means(860)

The chatting message transmitting means(860) transmits the real-time information related the chatting message(for example, ‘Do you looks like to rise the hanaro-communication?) received from the chatting message storing means(820) and ‘hanaro-communication’ received from the item information receiving means(850) to a plurality of user using the communications network.

Referring to FIG. 9b again, the area 900 of screen is output the chatting message(for example, ‘Do you looks like to rise the hanaro-communication? etc)input by ‘hong-gil-dong’ and the area 930 is output the real-time information related the item information (for example, ‘hanaro-communication’ etc) comprised in the conversation information.

Also, when the information called ‘33630 and KOSDAQ’ to transmit inputting for a special user is comprised, the real-time information about the corresponding item is provided by using the same step in the chatting message with the example.

The central server provides to a plurality of user the information corresponding to ‘33630’ among a plurality of code stored in ‘kosdaq’ using ‘33630 and kosdaq’ called the CONTENTS CONTROL COMMAND information.

Also, the central server provides to a plurality of user the information corresponding to ‘33630’ among a plurality of code when the chatting message comprises only numeral of ‘33630’

According to another preferred embodiment of the present invention, the service being connected with the chatting service and the real-time information can apply to a movie, music, a government, an economy etc.

For example, when service applies to the movie during the chatting in real time by a plurality of user, the special user inputs conversation information of “Genghis is interesting?“, information of cinema named Genghis khan about a genre, a play, a direction, appearing actors, appearing can apply to be output in real time by the similar step.

FIG. 9c and FIG. 9d are illustration of synchronization of chatting information and real time information in accordance with one preferred embodiment of the present invention and omits explanation of a overlapping part.

Referring to FIG. 9c, the chatting area(910) comprises the chat window to input conversation in the chatting message input area for the user to be able to input the chatting message and the whisper area.

The chat window area is area to input the chat information to request information of a special item or to input the chat information to output in all user terminals connected the same chat space. The whisper area is area to input the chat information to output only the special user terminal selected by the user.

Also, the chatting area(910) comprises information common selection area in the user information providing area simultaneously connecting the corresponding ‘chat rooms’. The information common selection area selects whether the information is held in common or not.

When the hong-gil-dong want to hold in common with ‘sung-chun-hang’ among a plurality of user the real-time information about ‘hanaro-communication’, the hong-gil-dong selects item of ‘share’ as described. And then, the real-time information for the hong-gil-dong to request is it output on screen of ‘sung-chun-hang’ selected for share the information like FIG. 9d the corresponding real-time information comprising the identification information of the hong-gil-dong

Referring to FIG. 9d, when sung-chun-hang doesn't want to search information of a special item output on screen by selection of information share function of the hong-gil-dong, the sung-chun-hang selects ‘reject ’ of selection item on the right of identification named hong-gil-dong in information share selection area and then the corresponding information is not output since the selecting time.

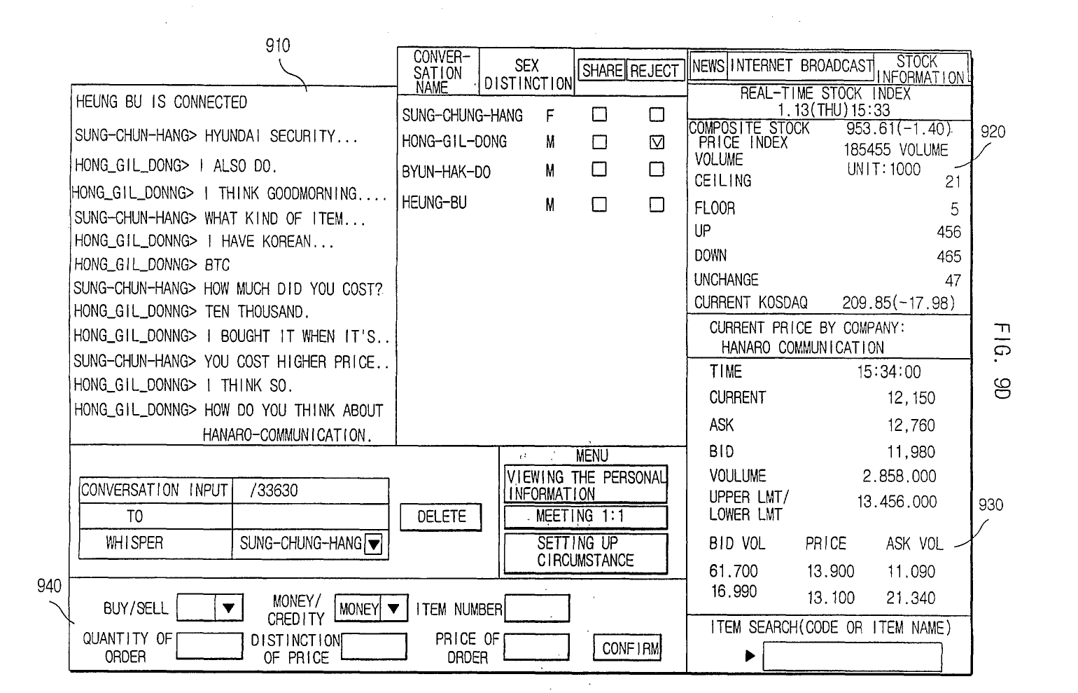

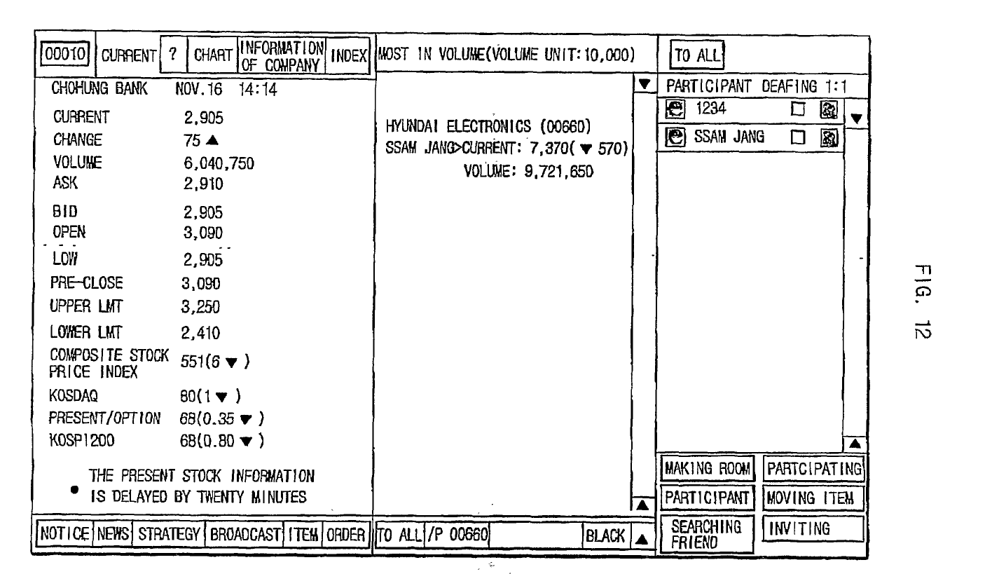

FIG. 10 and FIG. 12 are illustrations of synchronization of chatting information and real time information in accordance with another preferred embodiment of the present invention.

The FIG. 10 and FIG. 12 are drawings to present the type changing for the ‘chat room’ presentation screen to be output on the user terminal display connected the same ‘chat room’ in case of a special user inputting the CONTENTS TYPE APPOINTMENT COMMAND.

According to another preferred embodiment of the present invention, comparing the illustration to be shown in FIG. 10 and FIG. 12 with illustration explained previously referring to FIG. 9a and FIG. 9d, the real time information requested from the user is not output for the real time information providing area, but output for the chatting area directly. So an effect of concentration among the chatting participant can be presented.

Referring to the FIG. 10, the ‘chat room’ presentation screen to be output on the user terminal display may comprise the real-time information providing area(1000) and the chatting area(1020).

The real-time information providing area(1000) is area to provide the real-time (for example, the stock information, news etc) as explanation previously.

The chatting area(1020) may comprise the chatting message presentation area(1022), the chatting participant information area(1024), the chatting participant selection area(1026) and the chatting message input area(1028) etc.

The user connecting the ‘chat room’ inputs the chatting message for the chatting message input area(1028) and the user processes the chat by repeating the step to be output the input chatting message for the chatting message presentation area(1022).

The rest explains centering around that the user(presenting for the chatting participant information area(1024)) connected the ‘chat room’ inputs the CONTENTS CONTROL COMMAND and is provided the real-time information requesting.

Referring to FIG. 10, the user inputs the chatting message called ‘G 05930’ using the chatting message input area(1028).

And, the corresponding chatting message comprises the USER TYPE APPOINTMENT COMMAND of ‘/’ and the CONTENTS TYPE APPOINTMENT COMMAND ‘/G 05930’ as explanation previously.

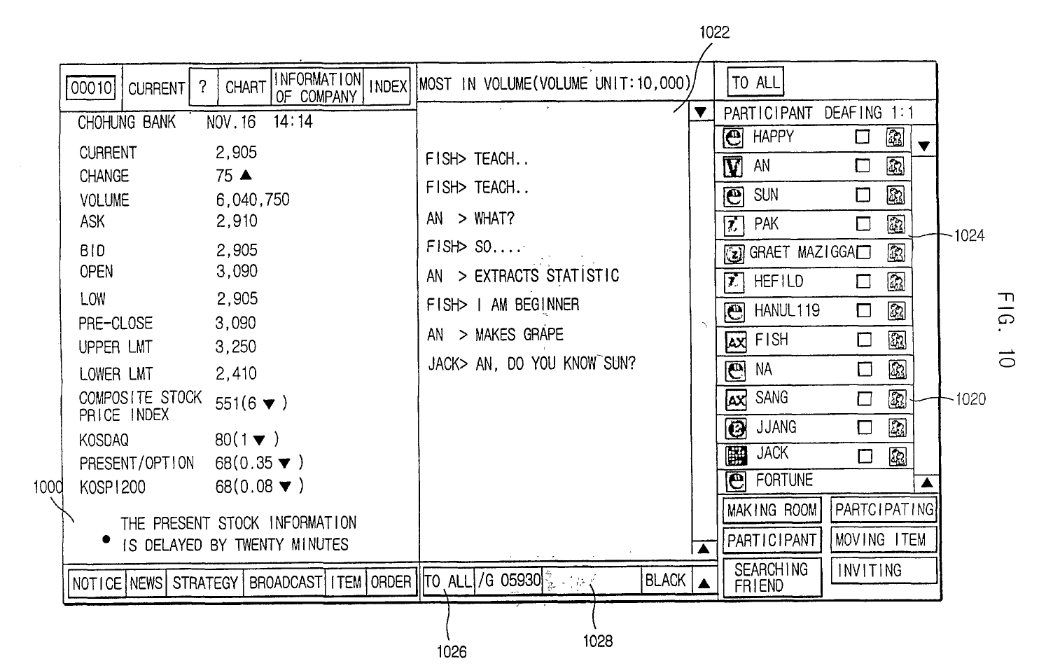

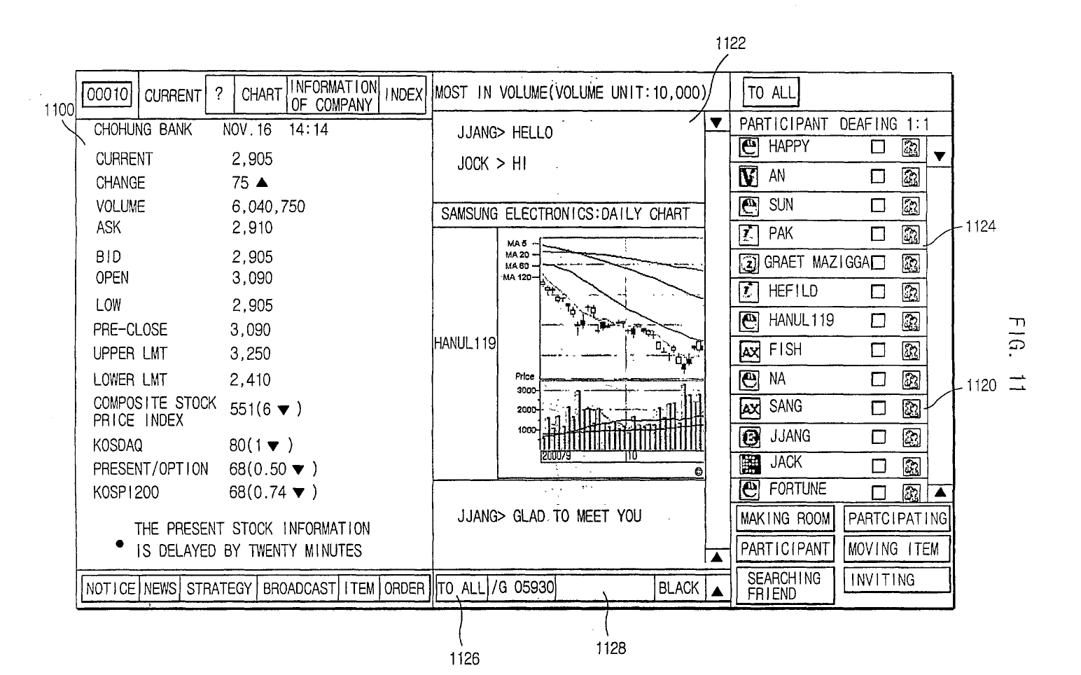

When the user input the chatting message called ‘/G 05930’ as illustrating FIG. 10, the corresponding user terminal display is output screen presentation like FIG. 11.

Referring to FIG. 11, real-time information(that is, a chart information) requested from the user is output in the chatting message presentation area(1122).

And, the real-time information displayed in the real-time information providing area(1000, 1100) is changed in accordance with a flow of time comparing FIG. 10.

That is, the real-time information output in the real-time information providing area(1000) of FIG. 10 is the real-time information corresponding to 11 month 16 day 14 hour 14 minute, the real-time output in real-time information providing area(1100)is the real-time information corresponding to November.16, 14 hour 16 minutes.

According to another preferred embodiment of the present invention, it is provided system and method for providing the real-time information being connected with the chatting service to able to take the place of the USER TYPE APPOINTMENT COMMAND using the chatting participant selection area(1026).

That is, when the user selects a special user using the chatting participant selection area(1026) and inputs the CONTENTS TYPE APPOINTMENT COMMAND, the corresponding contents can be output only the selected user terminal display.

And, when the user inputs the chatting message called ‘/P 00660’ as illustrating at FIG. 12, the corresponding user terminal display is output the screen presentation like FIG. 12.

That is, referring to FIG. 12, the real-time information requested from the user is output at the chatting message presentation area.

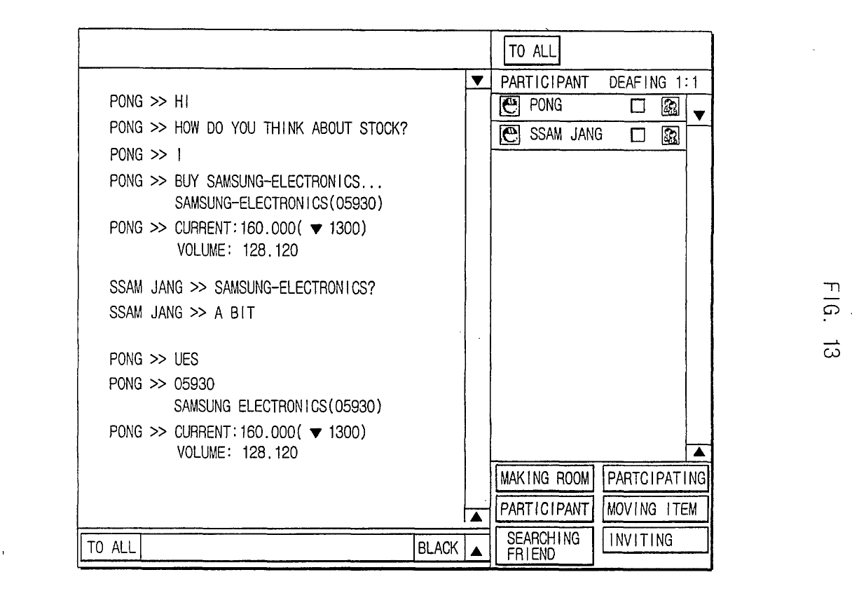

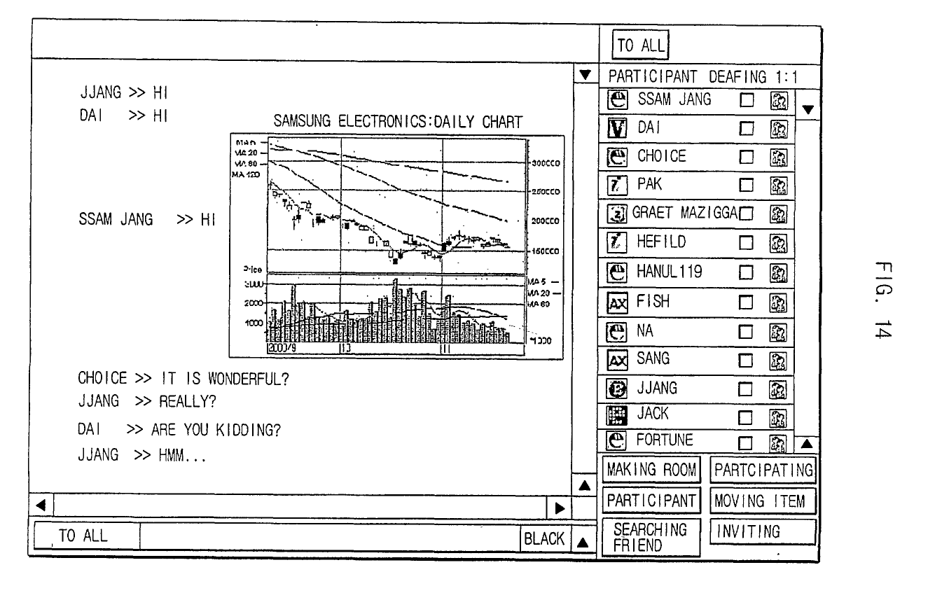

FIG. 13 and FIG. 14 are illustrations of the synchronization of chatting information and real time information in accordance with another preferred embodiment of the present invention;

The illustration to be shown in FIG. 13 and FIG. 14 doesn't comprise the real-time information providing area comparing the explained illustration referring to FIG. 10 and FIG. 12.

According to, the chatting participant can have the broader chatting area. And the real-time information can look forward to the greatest of concentration effect about the chatting and the real-time information being provided at the chatting area using the CONTENTS CONTROL COMMAND.

Because a method being provided the special real-time information at the chatting area describes previously at FIG. 13 and FIG. 14, concrete explanation omits.

And, the real-time information(for example, a chart, a current price etc) illustrated in FIG. 11 through FIG. 14 is moved gradually to the upper direction while the chatting among chatting participants is processed continuously and after all the real-time information is disappeared at the chatting area presented the user terminal display.(in fact, exists upper, but doesn't present)

In such a case, when the special user wants to process the chatting viewing continuously the corresponding real-time information by the mouse, the user selects the corresponding real-time information(for example, the current price, chart etc) and then the separate window is created and the window is displayed on the display unit of the user terminal and displayed continuously before the user selects other real-time information or the user ends the corresponding window.

Also, when the user selects the other real-time information, the other window is created separately and the user can refers the other real time information along with the previously selected real time information

Although the present invention has been described in terms of various embodiments, it is not intended that the invention be limited to these embodiments. Modification within the spirit of the invention will be apparent to those experienced in giving or receiving counseling.

### INDUSTRIAL APPLICABILITY

The present invention can provide, hold in common and use the information by outputting only special user appointed by the user a real-time information corresponding to a chatting message input by the user.

Also, the present invention can remove complication and limitations upon providing the latest information through the participation of members who chat about information that changes rapidly in real-time.

Also, the present invention process chatting efficiently because members are provided with brief and accurate information about rapidly changing conditions through the use of schematics.

Also, the present invention can transmit information of spontaneous type among the users because real-time information can be convertible automatically according to the request of the user

Also, the present invention can communicate future-directional and developmental by means of using the information.

Also, the present invention enables the chatting-participant to process chatting developmental based on correct reality by means of real time information provided in real-time

Also, the present invention can form space to enable communication protractedly and periodical.

Also, the present invention enhances the whole development of members because the members participating in chatting can discuss, study and predict through the information.

What is claimed is

1. A method for providing chatting service and contents on communications network, comprising the steps of:
receiving chatting message from a user terminal-the chatting message includes at least one selected from the group consisting of CHATTING CONTROL COMMAND and CONTENTS CONTROL COMMAND;
abstracting CONTENTS CONTROL COMMAND from the chatting message; and
controlling the contents displayed on the display unit of the user terminal corresponding with the CONTENTS CONTROL COMMAND;
wherein the CONTENTS CONTROL COMMAND includes at least one selected from the group consisting of USER TYPE APPOINTMENT COMMAND and CONTENTS TYPE APPOINTMENT COMMAND.

2. The method of claim 1,
wherein the USER TYPE APPOINTMENT COMMAND includes identification symbol to be determined beforehand,
the CONTENTS TYPE APPOINTMENT COMMAND includes at least one selected from the group consisting of identification code, item name and item code to be determined beforehand.

3. The method of claim 2,
wherein the identification symbol to be determined beforehand includes at least one selected from the group consisting of /, =, \, !, @, #, $, %, ˆ , &, *, ?.

4. The method of claim 1,
wherein the different identification symbol is assigned to the USER TYPE APPOINTMENT COMMAND according to the contents control range among the users who are participating in chatting.

5. The method of claim 1,
wherein the contents displays in a chat window providing the chatting service.

6. The method claim 5,
wherein the contents displayed in the chat window are displayed in separate window independently when the user requests.

7. The method of claim 1
wherein the contents are displayed in separate frame from the chatting service.

8. The method of claim 1,
wherein the step of controlling the contents according to the CONTENTS CONTROL COMMAND is the step of transmitting at least one selected from the group consisting of USER TYPE APPOINTMENT COMMAND and CONTENTS TYPE APPOINTMENT COMMAND to the server operating contents provision service

9. A method for providing chatting service and contents on a communications network, comprising the steps of:
receiving connection request information from a plurality of user terminals;
searching chatting program from a storage device;
transmitting the searched chatting program to the user terminal;
receiving connection request information from the chatting program stored in the user terminal;
transmitting initialization information of ‘chat room’ to the user terminal;
receiving chatting message from the user terminal, wherein the chatting message includes at least one selected from the group consisting of the CHATTING CONTROL COMMAND and the CONTENTS CONTROL COMMAND;
judging that the chatting message includes either CHATTING CONTROL COMMAND or CONTENTS CONTROL COMMAND; and
controlling corresponding service according to the judgment result,
wherein the step of controlling corresponding service according to the judgment result is the step of controlling the chatting service when the chatting message includes the CHATTING CONTROL COMMAND and controlling contents when the chatting message includes the CONTENTS CONTROL COMMAND.

10. The method of claim 9,
wherein the CHATTING CONTROL COMMAND includes at least one selected from the group consisting of conversation information, whisper information, synchronization share information and synchronization rejection information.

11. A method for providing chatting service and contents on a communications network, comprising the step of:
receiving connection request information from a user;
receiving environment setting information of a real-time information list desired by the user;
searching for the real-time information corresponding to the environment setting information of the real-time information list;
transmitting initialization information of the ‘chat room’ with the searched information to the user terminal simultaneously;
receiving chatting message from the user;
abstracting CONTENTS CONTROL COMMAND from the chatting message; and
controlling the contents displayed on display unit of the user terminal according to the CONTENTS CONTROL COMMAND.

12. The method of claim 11, further comprising the steps of:
receiving selection information of a plurality of users for contents share from the user terminal;
transmitting renewal request information of share user list to the user terminal, wherein the renewal request information of share user list renews user list for share of search information based on the received selection information.

13. The method of claim 11, further comprising the steps of;
receiving the user selection information for rejection of contents share from the user terminal; and
transmitting renewal request information of share rejection user list to the user terminal, wherein the renewal request information of share rejection share user list renews user list for share of search information based on the received selection information.

14. A method for using chatting service and contents on a communications network, comprising the step of;
transmitting chatting service performance request to the central server providing chatting service;
receiving chatting applet from the center server; and
being performed the received chatting applet automatically,
wherein the chatting applet performs the steps of:
being input chatting message from the user;
transmitting the chatting message to the central server;
receiving the chatting message from the central server; and
displaying the chatting message on display unit of the user terminal when the received chatting message must displayed on the display unit of the user terminal.

15. The method of claim 14, further comprising step of;
receiving at least one selected from the group consisting of contents and CONTENTS CONTROL COMMAND from the central server; and
displaying the contents on display unit of the user terminal when the received contents must displayed on the display unit of the user terminal.

16. The method of claim 15;
wherein the step of displaying the contents on the display unit of the user terminal, further comprising the step of,
recognizing URL included in contents;
connecting to the recognized the URL; and
receiving automatically information corresponding to the connected the URL.

17. The method for using chatting service and contents on communications network, comprising the steps of:
transmitting SCRREN DIVISION/ASSIGNMENT COMMAND dividing screen into a plurality of areas to a user;
receiving chatting message from the user;
judging that the received chatting message includes either CHATTING CONTROL COMMAND or CONTENTS CONTROL COMMAND;
providing service according to the judgment result; and
displaying contents relation transaction screen on the monitor of the user terminal when the service is provided.

18. The method of claim 17,
wherein the step of transmitting the SCRREN DIVISION/ASSIGNMENT COMMAND is at least one selected from the group consisting of the first area, the second area, the third area and the forth area-the first area outputs CHATTING CONTROL COMMAND represented by letters, the second area outputs a real-time information about item selected by the user, the third area outputs a real-time information related to CONTENTS CONTROL COMMAND information included in the chatting message and the forth area is area that the user inputs and transmits the transaction information-.

19. The method of claim 18,
wherein the forth area is assigned to command server for performing the contents relation transaction-the command server provides transaction service like stocks, presents or option on online-.

20. The method of claim 17,
wherein the content relation transaction screen includes link about web site for performing contents relation transaction.

21. A method for generating screen of chatting service and contents on communications network, a plurality of information areas displayed on a singular screen comprising:
the first area for outputting CHATTING CONTROL COMMAND represented by letters, wherein the CHATTING CONTROL COMMAND is input and transmitted from a plurality of users;
the second area for outputting real-time information about item selected by the user; and
the third area for outputting real-time information related to CONTENTS CONTROL COMMAND information included in chatting message of the user.

22. The method of claim 21, further comprising the forth area,
wherein the forth area is the area for inputting and transmitting transaction information based on information provided through a plurality of areas.

23. The method of claim 21,
wherein the third area further comprises the search area for searching special information input by the user.

24. The method of claim 21,
wherein the third area is displayed on the first area.

25. A system for providing chatting service and contents on communications network, the system comprising:
means for inputting chatting message from a user;
means for abstracting CONTENTS CONTROL COMMAND from the chatting message; and
means for controlling the contents according to the CONTENTS CONTROL COMMAND.

26. A system for providing chatting service and contents on communications network, the system comprising:
means for receiving connection request information from a plurality of user terminals;
means for searching chatting program from storage device and transmitting the chatting message to the user terminal;
means for receiving connection request information from chatting program stored in the user terminal;
means for transmitting initialization information of ‘chat room’ to the user terminal;
means for receiving chatting message from the user terminal;
means for judging that the chatting message includes either CHATTING CONTROL COMMAND or CONTENTS CONTROL COMMAND; and
means for controlling corresponding service according to the judgment result.

27. A system for providing chatting service and contents on communications network, the system comprising:
means for receiving environment setting information of a real-time information list desired by the user;
means for searching the real-time information corresponding to the environment setting information of the real-time information list;
means for transmitting initialization information of ‘chat room’ with the searched information to the user terminal simultaneously;
with transmitting the searched information to the user displaying on the user terminal;
means for receiving chatting message from the user;
means for abstracting CONTENTS CONTROL COMMAND from the chatting message; and
means for controlling the contents displayed on display unit of the user terminal according to the CONTENTS CONTROL COMMAND.

28. An apparatus for providing chatting service and contents on communications network, the apparatus comprising:
a storage device; and
a processor coupled to the storage device,
the storage device storing
a program for controlling the processor; and
the processor operative with the program to
receive chatting message from a user;
search CONTENTS CONTROL COMMAND from the chatting message; and
control the contents displayed on display unit of the user terminal according to the CONTENTS CONTROL COMMAND.

29. An apparatus for providing chatting service and on communications network, the apparatus comprising:
a storage device; and
a processor coupled to the storage device,
the storage device storing
a program for controlling the processor; and
the processor operative with the program to
receive connection request information from a plurality of user terminals;
search chatting program from a storage device;
transmit the searched chatting program to the user terminal.
receive connection request information from chatting program stored in the user terminal.
transmit initialization information of ‘chat room’ to the user terminal;
receive chatting message from the user terminal, wherein the chatting message includes at least one selected from the group consisting of CHATTING CONTROL COMMAND and CONTENTS CONTROL COMMAND;
judge that the chatting message includes either the CHATTING CONTROL COMMAND or the CONTENTS CONTROL COMMAND; and
control corresponding service according to judgment result,
wherein the step of controlling corresponding service according to the judgment result is the step of controlling chatting service when the chatting message includes the CHATTING CONTROL COMMAND and controlling contents when the chatting message includes the CONTENTS CONTROL COMMAND.

30. An apparatus for providing chatting service and contents on communications network, the apparatus comprising:
a storage device; and
a processor coupled to the storage device,
the storage device storing
a program for controlling the processor; and
the processor operative with the program to transmit SCRREN DIVISION/ASSIGNMENT COMMAND dividing screen into a plurality of areas to a user;
receive chatting message from the user;
judge that the received chatting message includes either CHATTING CONTROL COMMAND or CONTENTS CONTROL COMMAND;
control corresponding service according to the judgment result.
